(19) United States
(12) Patent Application Publication
(10) Pub. No.: US 2012/0265597 A1
(43) Pub. Date: Oct. 18, 2012

(54) SYSTEMS AND METHODS FOR FACILITATING PROMOTIONS

(75) Inventors: Sunil Saha, San Francisco, CA (US); Eric Bollman, San Francisco, CA (US); Vincent Bruns, Ridgecrest, CA (US); Ryan Showalter, Fresno, CA (US)

(73) Assignee: Perkville, Inc., San Francisco, CA (US)

(21) Appl. No.: 13/449,201

(22) Filed: Apr. 17, 2012

Related U.S. Application Data
(60) Provisional application No. 61/476,739, filed on Apr. 18, 2011.
(60) Provisional application No. 61/498,539, filed on Jun. 18, 2011.
(60) Provisional application No. 61/507,552, filed on Jul. 13, 2011.

(51) Int. Cl. G06Q 30/02

(52) U.S. Cl. 705/14.28; 705/14.66

(57) ABSTRACT

Embodiments of the present invention include systems and methods for providing incentives/promotion systems to users and businesses. Embodiments comprise an Internet-based platform enabling businesses to create and maintain their own reward programs and manage customers participating in them. In embodiments, businesses can customize, according to one or more factors (which factors may be obtained from data stored in the system), and track deals and other offerings to customers, potential customers, or both. Embodiments of the platform enable customers to view each business's rewards program, acquire and track rewards and other offering from multiple businesses using a single account offered via the platform. In embodiments, the centralized system allows users, businesses, or both to collaboratively create, promote, and/or redeem promotional activities.

### CROSS-REFERENCE TO RELATED APPLICATION

This application claims the priority benefit under 35 USC §119(e) to commonly assigned and co-pending: U.S. Patent Application No. 61/476,739 (Attorney Docket No. 20091-1604P), filed on 18 Apr. 2011, entitled “Rewards System,” listing as inventors Sunil Saha and Eric Bollman; U.S. Patent Application No. 61/498,539 (Attorney Docket No. 20091-1611P), filed on 18 Jun. 2011, entitled “Simplified User Identifier Entry,” listing as inventors Sunil Saha, Eric Bollman, and Vincent Burns; and U.S. Patent Application No. 61/507,552 (Attorney Docket No. 20091-1617P), filed on 13 Jul. 2011, entitled “Improved Deal System,” listing as inventors Sunil Saha, Eric Bollman, and Ryan Showalter. Each of the aforementioned patent documents is incorporated by reference herein in its entirety.

### BACKGROUND

A. Technical Field

The present invention pertains to systems and methods for facilitating and implementing various rewards and incentives programs.

B. Background of the Invention

Because of the ever increasing competition between businesses, companies have employed customer rewards programs. A customer rewards program traditionally involves incentivizing customers of a business to use the business. These customer rewards programs generally range from stamp cards or punch cards at the local establishments to more involved reward programs, such as those offered by hotel chains, airlines, or credit card companies. The purpose of these reward systems is usually to encourage repeat customer business.

Because various companies may implement rewards programs, customers usually have an account or card for each of the reward programs in which they participate. When a customer desires to participate in a rewards program, the customer must typically register or otherwise create an account by supplying personal details. Customers usually must do this for each rewards program; thereby requiring them to reenter the same or similar information each time they join a program. In addition, to providing their personal data (e.g., name, phone, email, address, etc.) to each business, the customer must make sure that any changes in data get supplied to each business for which they maintain a rewards program.

As previously mentioned, one way in which businesses often implement rewards programs is to give each of their participating customers a card as a way to identify the customer in the rewards program. If a customer participates in a number of rewards programs, the customer must then carry several cards, one card for each rewards program, which becomes cumbersome and inconvenient. It is not uncommon for customers to lose these cards or forget to bring them to the business. The added burdens of having to carry a number of cards or forgetting the card and not getting credited can create customer frustration. Thus, a program intended to promote goodwill between a business and its customer can, because of the way in which it is implemented, produce the opposite—indifference or even resentment.

In addition to reward programs for single companies, reward system networks have been developed in which customers may be rewarded for purchasing from any business in the network. In this case, customers can use a single identifier across many businesses, but the rewards that can be redeemed for a particular purchase are not exclusive to the business that the customer purchased from. The rewards, instead, generally come in the form of cash back or discounts, products or services from any business in the network. One problem with such reward system networks is that because rewards can be earned and redeemed at many businesses and not just the business where the purchase occurred, the incentive to visit any one business where a purchase occurred is less, and consequently, the efforts to engender customer loyalty is greatly diluted.

Other issues exist with prior attempts to create rewards programs. For a business to implement anything other than a simple stamp card or punch card rewards system can involve expense and technical effort. For small and medium-sized business, considerable efforts required can be prohibitive, leaving them to implement less costly, but far less sophisticated rewards programs. Although stamp cards or punch cards are typically much less costly to implement, they are not without problems. For example, indicators for stamp cards and punch cards can be faked relatively easily, which can result in small businesses having to pay out more in rewards than they should. Also, these methods do utilize resources, such as printing and paper goods. With increasingly more attention being paid to reducing the environmental footprint of businesses, these stamp and punch cards add environmental impact.

Thus, previous attempts to implement customer rewards programs have been limited at best and are often ineffectual. Such programs, because of the way in which they are implemented, have even produced customer antipathy.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows various components of a reward system platform according to embodiments of the present invention.

FIG. 2 shows that the reward system platform interacts with external parties, customers, and businesses according to embodiments of the present invention.

FIG. 3 shows a form used to register businesses according to embodiments of the present invention.

FIG. 4 shows a form a business can use to create its reward program according to embodiments of the present invention.

FIG. 5 shows various components used by a business to manage rewards according to embodiments of the present invention.

FIG. 6 shows a process for awarding customers according to embodiments of the present invention.

FIG. 7 shows a form for awarding customers according to embodiments of the present invention.

FIG. 8 shows a form for a pending customer to accept an award according to embodiments of the present invention.

FIG. 9 shows connections formed between businesses and customers when awards are accepted according to embodiments of the present invention.

FIG. 10 shows a process for redeeming awards for customers according to embodiments of the present invention.

FIG. 11A shows a process for checking a customer's balance according to embodiments of the present invention.

FIG. 11B shows a page a business can use to search for a customer according to embodiments of the present invention.

FIG. 11C shows a page showing customer results from a search according to embodiments of the present invention.

FIG. 11D shows a page showing a customer and his rewards balance according to embodiments of the present invention.

FIG. 12 shows a form for redeeming rewards for customers according to embodiments of the present invention.

FIG. 13 shows how users are registered according to embodiments of the present invention.

FIG. 14 shows a registration invitation according to embodiments of the present invention.

FIG. 15 shows a customer registration form according to embodiments of the present invention.

FIG. 16 shows a business profile according to embodiments of the present invention.

FIG. 17 shows a single identification used across many reward programs according to embodiments of the present invention.

FIG. 18 shows a page for viewing reward balances across several businesses according to embodiments of the present invention.

FIG. 19 shows technology components of the reward system platform according to embodiments of the present invention.

FIG. 20 shows database tables in the reward system platform according to embodiments of the present invention.

FIG. 21 shows the various alternatives to interact with the reward system platform according to embodiments of the present invention.

FIG. 22 depicts business and customer interacts capable via the reward system according to embodiments of the present invention.

FIG. 23 depicts an embodiment of a configuration in which a terminal is provided to allow a user to record a visit to a business according to embodiments of the present invention.

FIG. 24 depicts an embodiment of a configuration in which a terminal or client module is provided to allow a user to record a visit according to embodiments of the present invention.

FIG. 25 depicts system interactions for providing simplified user email entry according to embodiments of the present invention.

FIG. 26 depicts a method for assisting a user in entering his or her email address according to embodiments of the present inventions.

FIG. 27 depicts an example display with a user entry according to embodiments of the present invention.

FIG. 28 depicts an example display with an updated user entry according to embodiments of the present invention.

FIG. 29 depicts a terminal provided to allow a user to record a visit to a business according to embodiments of the present invention.

FIG. 30 depicts an embodiment of a display in which the user is notified of winning after having recorded her business visit according to embodiments of the present invention.

FIG. 31 illustrates, by way of example and not limitation, a set of deals offered at different times to different recipients.

FIG. 32 depicts an embodiment of a combined loyalty platform system and deal platform system according to embodiments of the present invention.

FIG. 33 depicts an example of an interface that may be used to create a deal according to embodiments of the present invention.

FIG. 34 depicts an embodiment of a deal system for sending deal announcements to recipients according to embodiments of the present invention.

FIG. 35 depicts an example of a deal announcement sent to a recipient according to embodiments of the present invention.

FIG. 36 depicts examples of communication means and interactions between these communication means, users/recipients, and a deal system according to embodiments of the present invention.

FIG. 37 depicts an example of an interaction between users and a deal system that includes a deal marketplace according to embodiments of the present invention.

FIG. 38 depicts a database structure according to embodiments of the present invention.

FIG. 39 depicts a block diagram of an example of a computing system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Also, it shall be noted that steps or operations may be performed in different orders or concurrently, as will be apparent to one of skill in the art. And, in instances, well known process operations have not been described in detail to avoid unnecessarily obscuring the present invention.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules. Components or modules may be implemented in software, hardware, or a combination thereof.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

Embodiments of the present invention presented herein will be described using web applications examples. These examples are provided by way of illustration and not by way of limitation. One skilled in the art shall also recognize the general applicability of the present inventions to other applications. Aspects of the current inventions involve facilitating the process of offering deals to consumers. It shall be noted that the systems and methods disclosed herein may be used for other purposes besides consumer deals and rewards programs, including promotions for non-commercial or non-monetary reasons; accordingly, references to “business” or “establishment” may be a commercial or non-commercial “business.” It shall be noted that terms “deal,” “rewards,” “promotion,” “incentive,” “loyalty program,” and “offer” may be used to have the same or similar meanings. It shall also be noted that the terms “contact,” “consumer,” “customer,” “client,” “individual,” “recipient,” “patron,” “user,” and the like may be a person, a group of people, or an entity, such as business, establishment, collective, group, corporation, non-profit, organization, and so forth.

### A. Overview

Due to the ineffectual results achieved by prior customer rewards programs, what is needed are systems and methods by which customer rewards programs can be easily implement, are not so limited, and can increase business for companies that implement such programs.

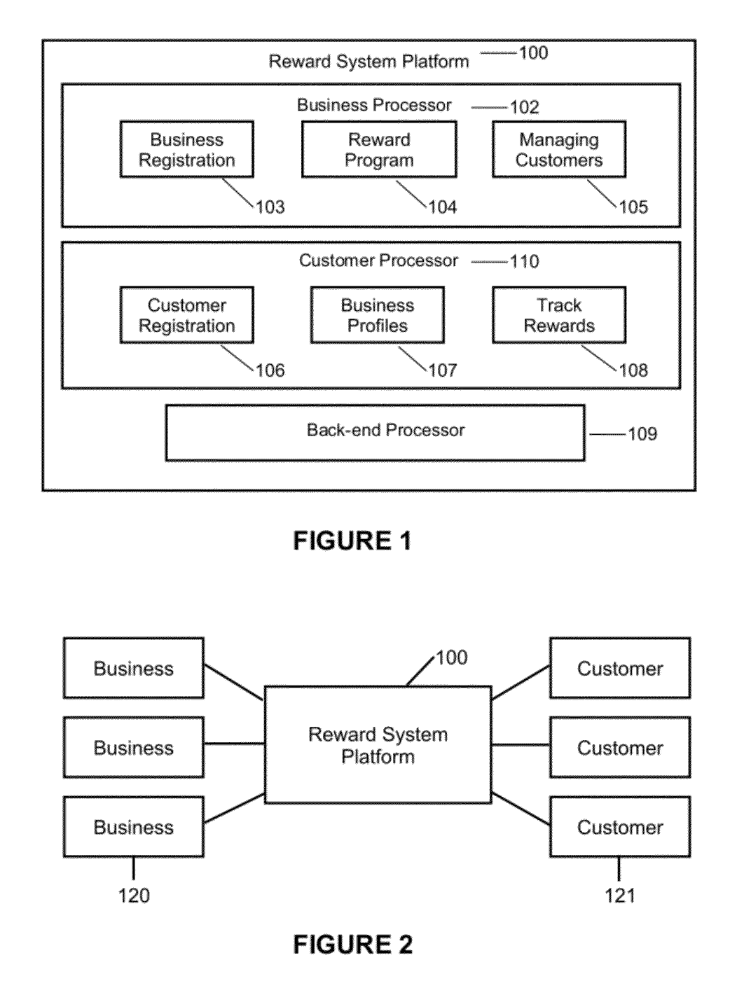

An embodiment of the reward system platform is illustrated in FIGS. 1 and 2. The reward system platform may be used by businesses 120 and their customers 121. FIG. 1 shows various components of a reward system platform according to embodiments of the present invention. FIG. 2 shows that the reward system platform interacts with external parties, customers, and businesses according to embodiments of the present invention.

As depicted in FIG. 1, in embodiments, the reward system platform comprises functionality for both businesses 102 and customers 110 and is powered by back-end technology 109.

In embodiments, the business processor functionality includes business registration 103, the ability for businesses to create and maintain their reward program 104, and the ability for them to manage customers that are participating in their rewards program 105. One skilled in the art shall recognize that other business functionality may also be included with or provided by reward system platform 100.

In embodiments, the customer processor functionality includes customer registration 106, the ability to view business profiles 107, and the ability to track rewards across multiple reward programs using a single account and in a single location 108. One skilled in the art shall recognize that other customer functionally may also be included with or provided by reward system platform 100.

### B. General Description

1. Business Registration

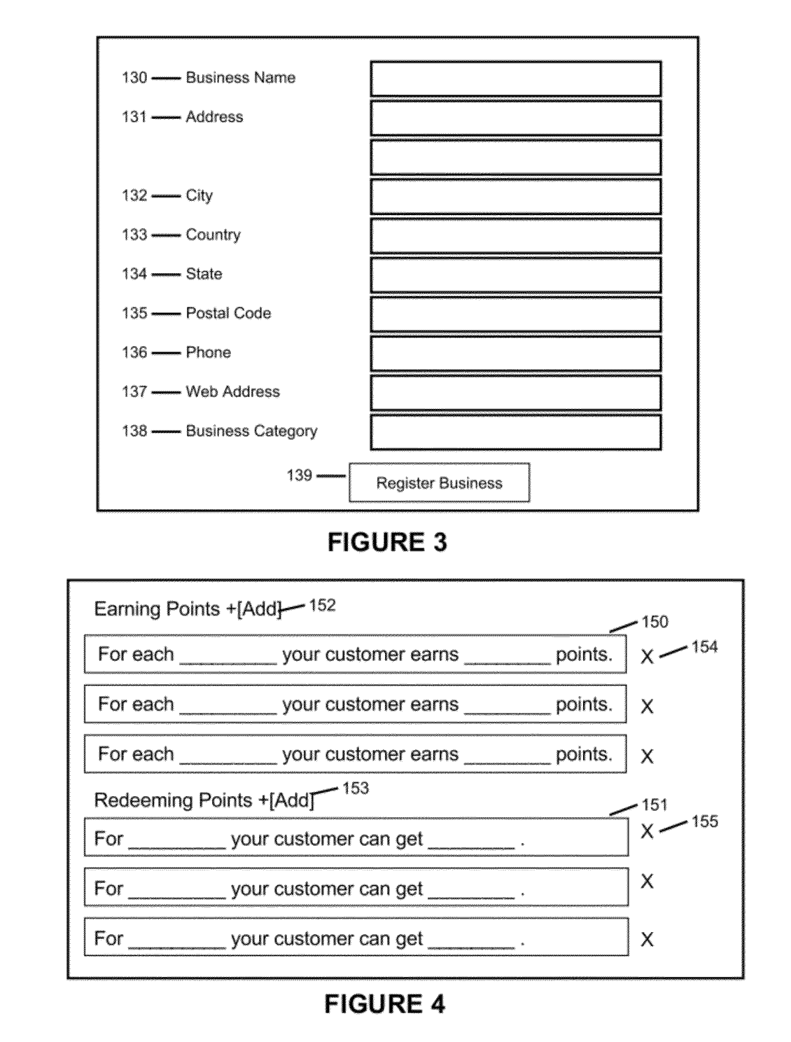

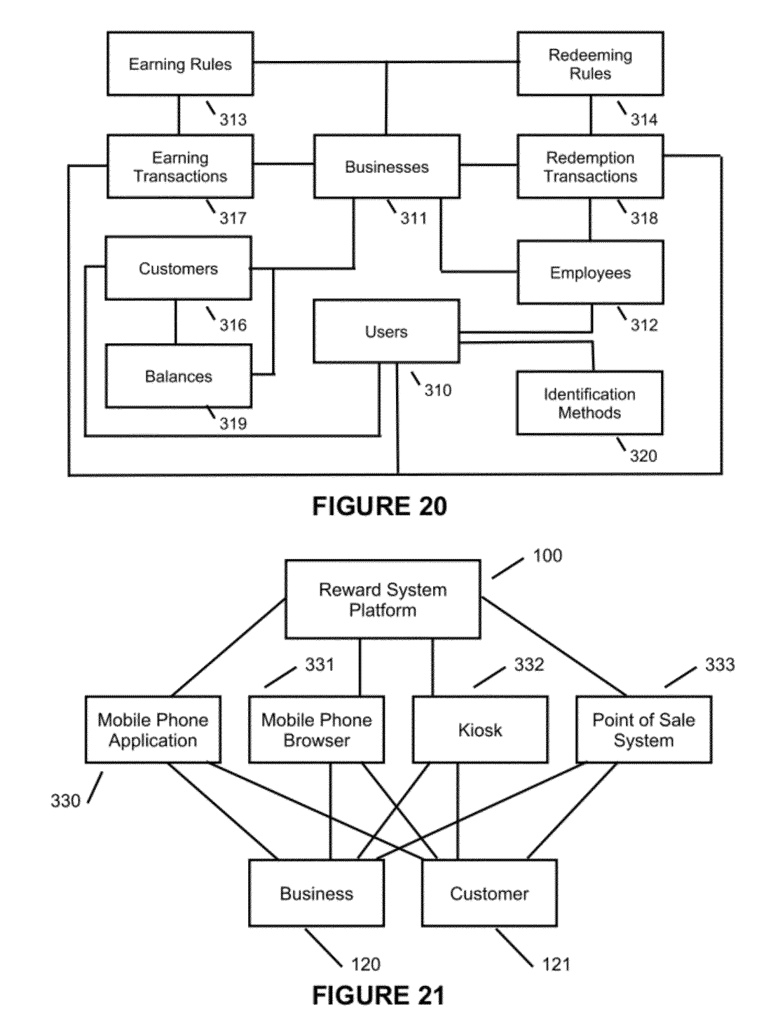

Customer registration is covered later in FIGS. 13-17. In embodiments, customers that have registered can subsequently register their business in the reward system platform. FIG. 3 illustrates an embodiment of a form to capture basic information about the businesses that register. The form illustrates fields 130-138 that can be entered to register the business. A “Register Business” button 139 can be clicked to save the information entered in the fields to a database discussed later in FIG. 20. One skilled in the art shall recognize that multiple locations can be registered or tracked separately for each business so that reward transactions and customer participation can be tracked by location.

2. Reward Program

Each registered business can create its own rewards program 104. FIG. 4 shows a form that may be used to enable businesses to create a rewards program according to embodiments of the present invention. In one embodiment, the business can specify how customers may earn points 150 by entering the number of points a customer will receive for the purchase of a product or service or for any other activity that the business would like to incentivize. The business can also specify how customers can redeem points by indicating the number of points required to redeem a reward 151. Rules for earning points or redeeming points can be added 152-153, edited, and removed 154-155.

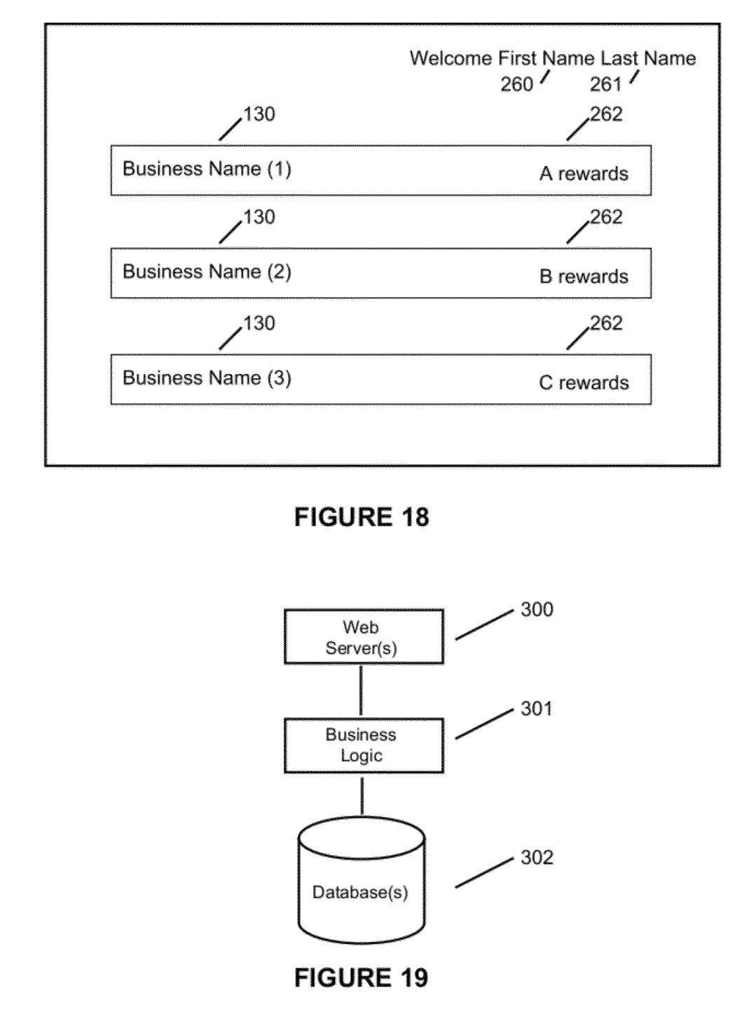

In embodiments, the rewards program is displayed to customers in the business profile 107, which is described later with regard to FIG. 18.

3. Managing Customer Rewards

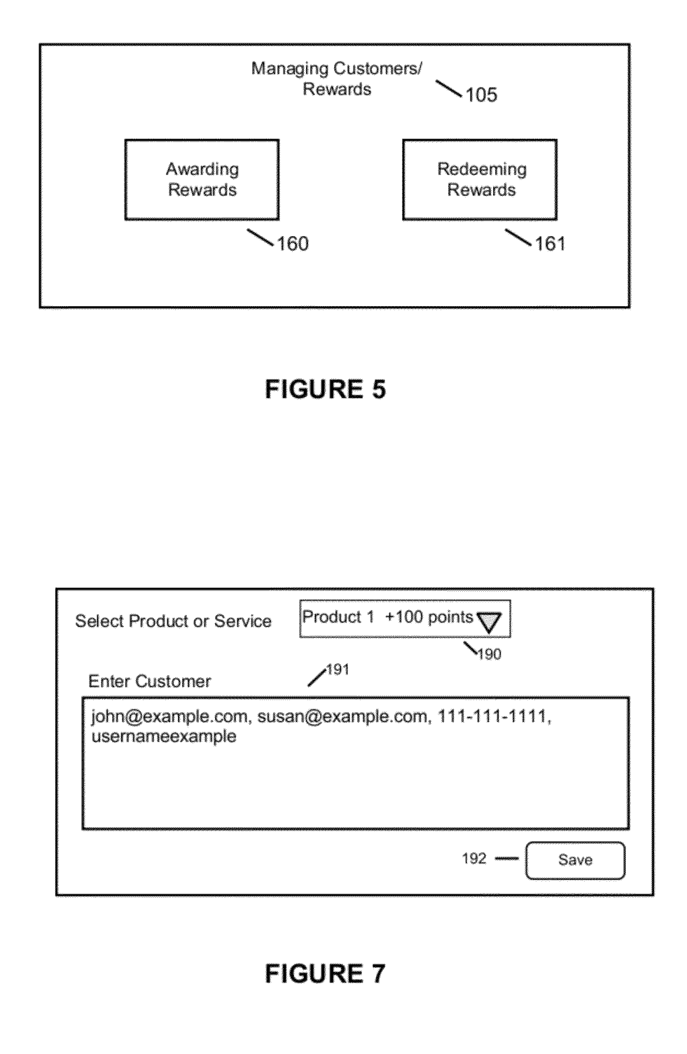

FIG. 5 shows two components of managing customers 105 according to embodiments of the present invention. In embodiments, the managing customer rewards processor or module includes managing of awarding rewards 160 and of redeeming rewards 161.

a) Awarding Rewards

FIG. 7 depicts an embodiment of a form that may be used by a business to reward customers according to embodiments of the present invention. The product or service for which the customer is receiving the reward can be selected 190. One skilled in the art shall recognize that this is not limited to products and services and can also be any other activity that the business would like to incentivize, such as spending money at a shop, checking into a gym to work out, etc. In embodiments, the product or service may be selected from a populated list. Alternatively, the business may enter the product or service for which the customer is receiving the reward. The customer or customers that are receiving a reward or rewards may be selected or entered 191. A save button 192 may be selected to commit the information to the database. In embodiments, the earning rule, quantity and customer may also be provided to the reward platform via automated means such as through integration with the business's point-of-sale or scheduling system.

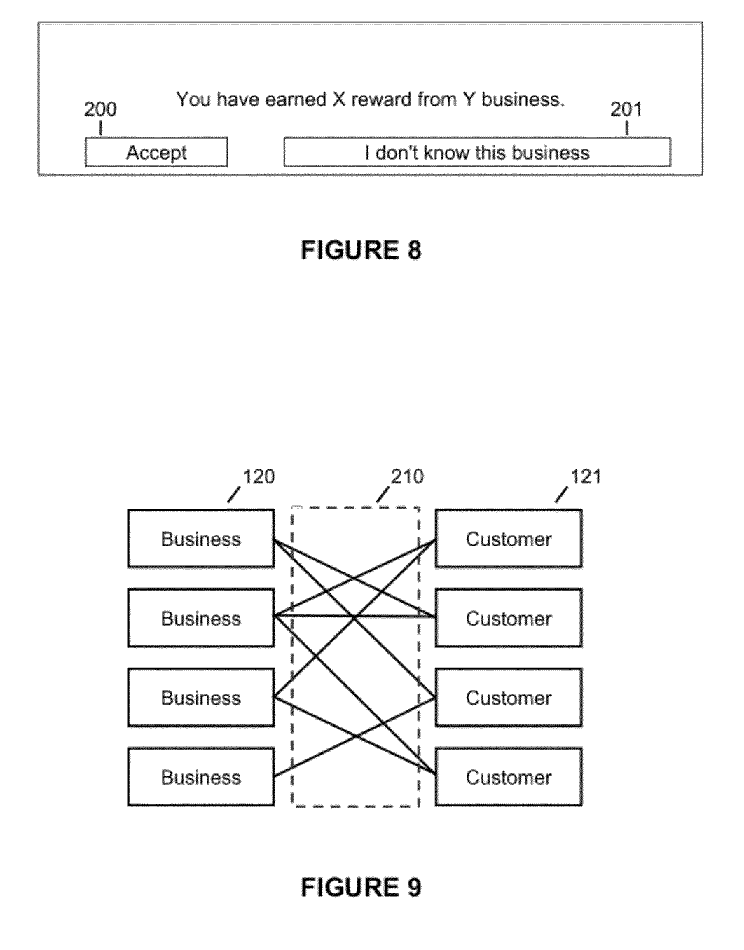

FIG. 8 depicts a form in which the customer can accept or reject the reward according to embodiments of the current invention. In embodiments, by clicking “Accept” 200, the customer accepts the reward. In embodiments, by clicking “I don't know this business” 201, the customer would reject the reward and cancel the reward 178. Having customers affirmatively accept the reward allows the reward system platform to track malicious businesses that use the platform to spam or otherwise contact people that are not real customers. A business that gets too many “I don't know this business” 201 can be flagged as a potentially malicious business and can be denied access to the reward system platform. In embodiments, clicking “Accept” 200 creates an electronic connection between the customer and the business and negates the need to perform this step for future rewards because the customer will have verified himself as a customer of the business. One skilled in the art shall recognize that the platform can also function without the explicit step of first accepting the reward and that instead, the connection could be automatically created.

b) Redeeming Rewards Benefit

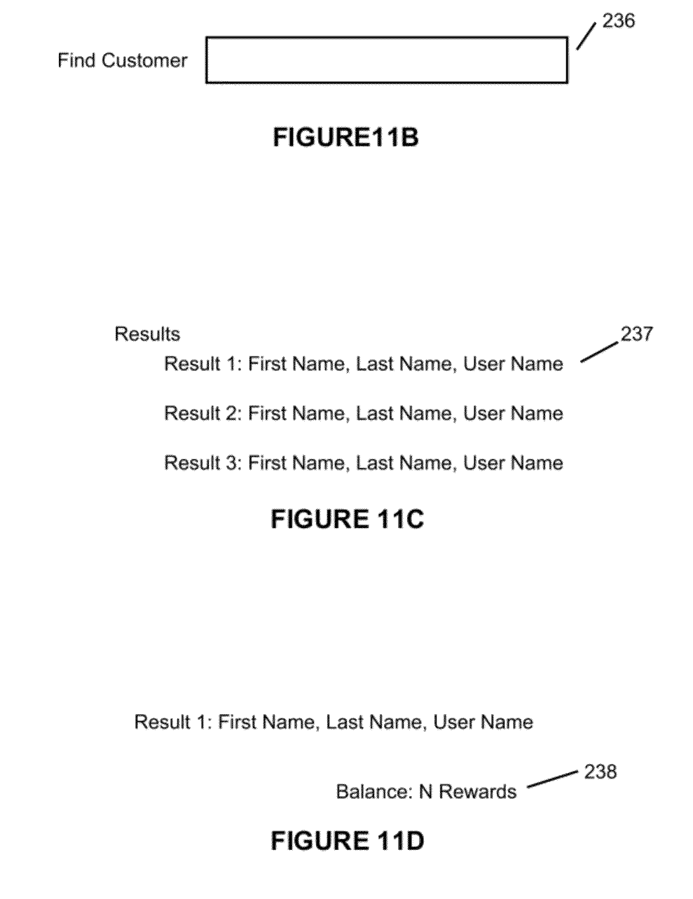

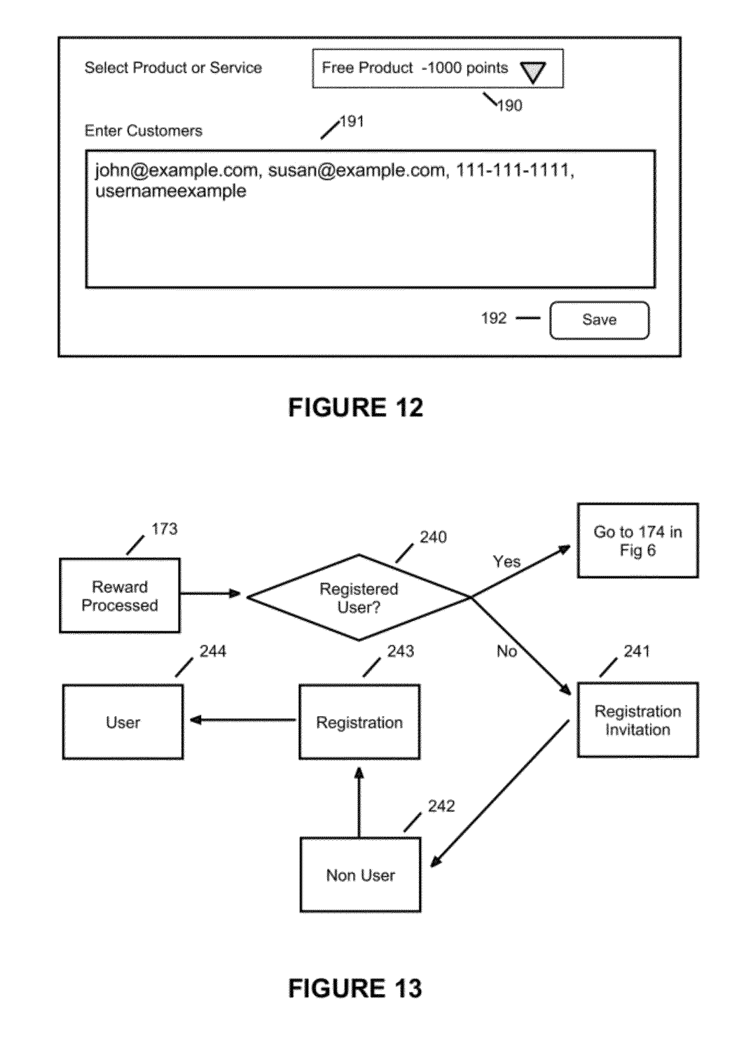

FIG. 11B-11D depicts examples of pages a business can use to determine whether a customer has enough rewards to redeem a benefit according to embodiments of the present invention. The interface page depicted in FIG. 11B has a field 236 used to search for customers by an identifier. In embodiments, the embodiments may be one or more of: first name, last name, user name, email address, ID number, and the like. One skilled in the art shall recognize that a number of search fields, operators, and operations (such as, by way of example and not limitation, nested searching) may be provided by the rewards system.

FIG. 11B depicts a page that displays example customer search results 237. In embodiments, the search result includes each customer that met the search query criterion or criteria. In embodiments, those matching customers may be presented by showing each customer's first name, last name, and/or user name, although other information may be presented. In embodiments, the displayed results may include links to additional information about each customer, such as a customer's public profile page.

In embodiments, a customer search, or the selection of a customer from a search list or customer list, may display information related to the customer's rewards status. For example, FIG. 11D depicts a page that shows the balance for an individual customer 238. In embodiments, other data associated with the customer may also be displayed. This information may include contact information, rewards history, rewards status, connections to customers, connections to businesses, profile information, etc.

FIG. 12 illustrates a form that may be used by a business to redeem rewards for customers according to embodiments of the present invention. In embodiments, the reward system provides an interface for the business to enter the customer or customers that are receiving a reward 191. In embodiments, the customers and the reward product, service, discount, or the like may be selected from a populated list. Alternatively, the business may enter one or more of the customers and the rewards. In embodiments, a save button 192 is selected to commit the information to the database for recording the reward payout and for execution.

In embodiments, customers may be able to “self redeem” if the business has allowed such in its configuration at the rewards system platform. For example, in embodiments, a customer may redeem points on their own by creating a voucher that can be used at the business. Thus, one skilled in the art shall recognize that the redemption of rewards points may be done at defined milestones or may be done at a continuous or user-selected level. One skilled in the art shall recognize that methods other than a voucher can also be employed for the customer to claim the reward at the business. For example, the reward (e.g., $10 off any purchase, a free coffee, etc.) may be automatically added to the customer's account at the respective business so that they don't have to bring in a voucher to claim the reward.

4. Customer Registration

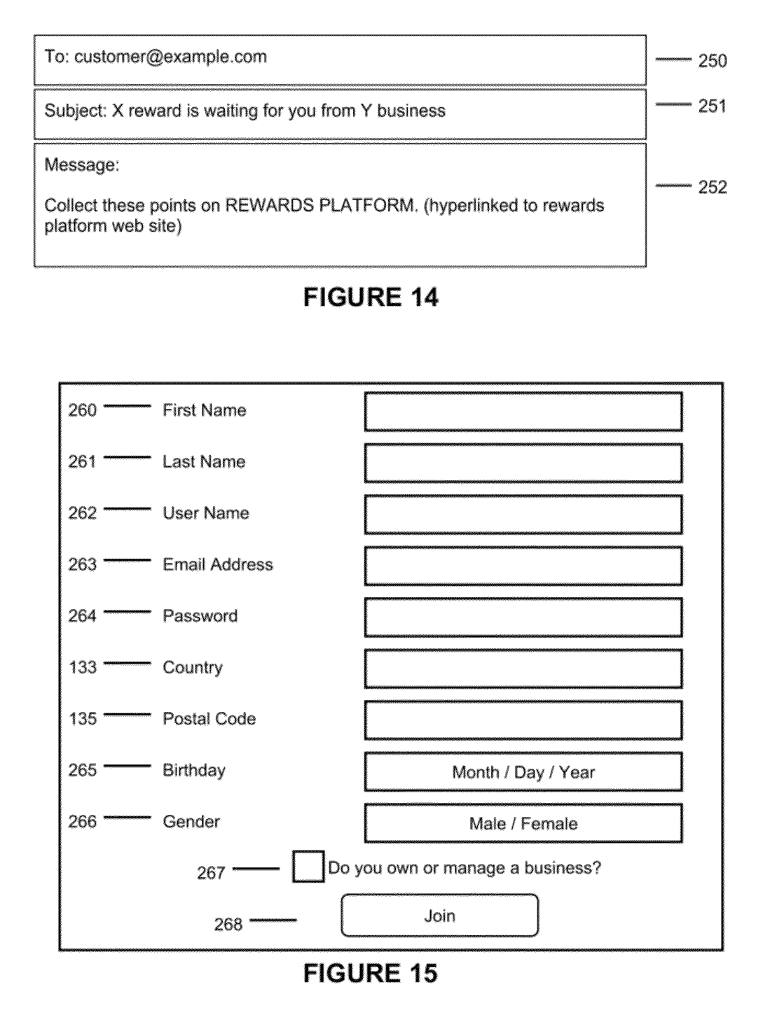

FIG. 14 illustrates a registration invitation email according to embodiments of the present invention. In embodiments, the email contains the email address 250 of the non-user to receive the message. The email may contain a subject line 251 indicating that a reward is waiting for the non-user individual. In embodiments, the email contains a message 252 prompting the recipient to take some action, such as clicking or otherwise selecting an included link, to collect the reward. Alternatively, the email may provide instructions to the recipient to register with the rewards system.

FIG. 15 illustrates a form for customer registration according to embodiments of the present invention. In the depicted embodiment, a number of fields 260-267 may be presented to the registrant for customer registration. By entering at least some of the data, which may be pre-populated, and selecting the “Join” button 268, the registrant information entered on this page can be committed to the database. One skilled in the art shall recognize that fewer or more fields can be used to register the customer.

5. Business Profile

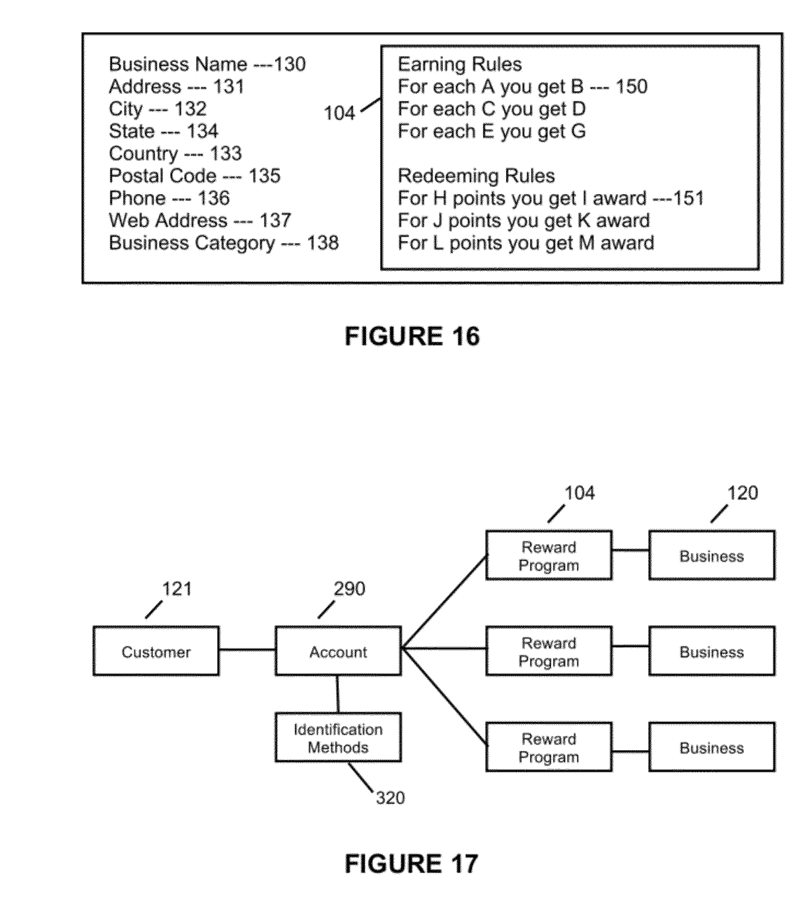

FIG. 16 illustrates a business profile that may exist for each business on the reward system platform according to embodiments of the present invention. In embodiments, the profile may include the information the business entered during business registration 130-138 and the rewards program information for the business 104. In embodiments, the reward program contains the rules for earning rewards 150 and redeeming rewards 151. In embodiments, the profile may also include redeeming perks, rewards history, connections to other businesses, connections to customers, and the like. In embodiments, the business profile includes a listing of customers, which may be used by the business. In embodiments, the customer listing, or search results of customers, may be exported by a business. One skilled in the art shall recognize that more than one location can be displayed on the profile for multi-location businesses.

6. Tracking Rewards

FIG. 18 depicts how a customer 121 may be shown rewards across multiple businesses in a single user interface (such as a web page) according to embodiment of the present invention. In embodiments, the interface lists the first name 260 and last name 261 of the customer at the top of the page. In embodiments, the interface lists the businesses 120 using the business name 130 where the customer has rewards 262, enabling the customer to track rewards 262 across multiple businesses 120 in a single location. In embodiments, interface may include, or may include links to, detailed information about the business, rewards history (which may include rewards earned, redeemed, or otherwise transacted), and the like.

7. Back-end Technology

FIG. 19 depict back-end technology components that can be used to build a reward system platform according to embodiments of the present invention. In embodiments, one or more web servers 300 are used to communicate with business 120 and customer 121 devices, such as computers, mobile phones, etc. and to deliver web pages and information to them. In embodiments, a business logic layer 301 performs the data query, entry, update, and report processing between the web server 300 and the databases 302. The business logic layer may also store and run all of the business logic. In embodiments, the business logic may perform one or more of the methods or functions disclosed herein. In embodiments, one or more databases 302 store data for the reward system platform.

FIG. 20 illustrates database tables that may be included in the reward system platform according to embodiments of the present invention. In embodiments, users of the reward system platform are stored in a table 310. This table 310 may be connected to a customers table 316, and this connection may keep track of when a user accepts a reward from a business so that the reward system platform knows the user is a valid customer of the business. In embodiments, this can establish the business to customer connections shown in FIG. 9. In embodiments, this table 316 may also be called a “connections” table and keep track of the status of each connection, either accepted, pending or declined.

In embodiments, the users table 310 can also be connected to an employees table 312 because a user may be an employee of a business in the reward system platform. In embodiments, the employees table 312 may be connected to a businesses table 311 to indicate for which business the employee works. In embodiments, the customers table 316 may also be connected to a businesses table to indicate of which businesses the user is a customer. In embodiments, a balances table 319 connects the customers table 316 and the businesses table 311 to track the customer reward balance at each business. In embodiments, the balances table 319 may also connect directly to the users table 310.

In embodiments, the users table 310 and the businesses table 311 may be connected to the earning transactions table 317 and the redemption transactions 318 to track the transactions between businesses and users. In embodiments, the earning transactions table 317 may be connected to the earning rules table 313 to keep track of which rule each earning transaction was from and the redemption transactions table 318 may be connected to the redeeming rules table 314 to keep track of which rule each redeeming transaction was from. In embodiments, the system may integrate earning transactions 317 and redeeming transactions 318 into a single table and use a column within the table to instead determine the type of transaction, earning or redeeming.

In embodiments, the earning rules table 313 and the redeeming rules table 314 may be connected to the businesses table 311 to keep track of which rules were created by and are for each business. In embodiments, the system may determine what kind of rule the transaction was for because the transaction table links to the rule table using the rule ID; therefore, the earning rules table 313 and the redeeming rules table 314 may be integrated into a single table in embodiments.

Finally, in embodiments, the users table 310 can be connected to the identification methods table 320 so that a user can have multiple forms of identification all tied to one user account (e.g. email address(es), mobile phone number(s), card with bar code, etc.). It shall be noted that there are various alternatives that can be used for the identification of a customer, such as a card with a bar code, a mobile phone number, several email addresses, etc. These various alternatives can all be tied to a single user account described in the embodiments above so that the customer can use different forms of identification as he chooses. For example, he may choose to use his email address at one business and his mobile phone number at a different business and the transactions will tie to his single account. These methods may be stored, such as by way of example, in the Identification Methods table 320 in FIG. 20.

One skilled in the art shall recognize that more or fewer databases may be used. In embodiments, there may also be a table of each businesses' locations that connect to the businesses table 311, earning transactions table 317, redemption transactions table 318 and customers table 316. One skilled in the art shall recognize that one or more of the databases may be combined together and that these tables may be connected in more or fewer ways.

### C. Operations

As previously noted, the rewards system platform may be used by businesses 120 and their customers 121. As shown in FIG. 2, the reward system platform 100 forms a nexus that allows one or more of businesses to easily establish a rewards program or programs and provides a convenient and easy system for customers to record and track rewards.

1. Reward System Platform Deployment

In embodiments, the reward system platform 100 is deployed so that businesses 120 and their customers 121 can utilize it. For example, in embodiments, the components in FIG. 19 are hosted on one or more servers and deployed such that people can access the reward system platform over a network, such as the Internet.

2. Business Registration

In embodiments, an employee of a business completes a subset of customer registration steps, such as those shown in FIG. 13. In embodiments, the employee will initially be a non-user 242. In embodiments, she can complete registration 243 to become a user 244, and her information will be stored, for example, in the users table 310 in FIG. 20. In embodiments, she can register by submitting a form, such as the one shown in FIG. 15, by entering the information in fields 260-267 and by selecting the “Join” button 268.

In embodiments, the employee can register her business 103 by completing a form, such as the one shown in FIG. 3, by entering the information in fields 130-138 and by selecting the “Register Business” button 139. In embodiments, the business's information is stored, for example, in the businesses table 311 in FIG. 20.

3. Reward Program

With a business account, a business representative (such as the employee) can create a reward program for their business by completing a form, such as the one depicted in FIG. 4. In embodiments, the employee can enter earning rules 150, and redeeming rules 151. She can add more earning rules if needed by clicking “Add” 152 and more redeeming rules if needed by clicking “Add” 153. In embodiments, she can also delete earning rules by clicking “X” 154 and delete redeeming rules by clicking “X” 155. In embodiments, the business may set other conditions for receiving and/or redeeming. For example, the business may set time limits, redemption limits, and so forth.

In embodiment, the submitted information is stored in the appropriate database. For example, in embodiments, the earning rules are stored in the earning rules table 313 and the redeeming rules are stored in the redeeming rules table 314 in FIG. 20. One skilled in the art shall recognize that other data storing schemes may be employed.

4. Awarding Customers Rewards

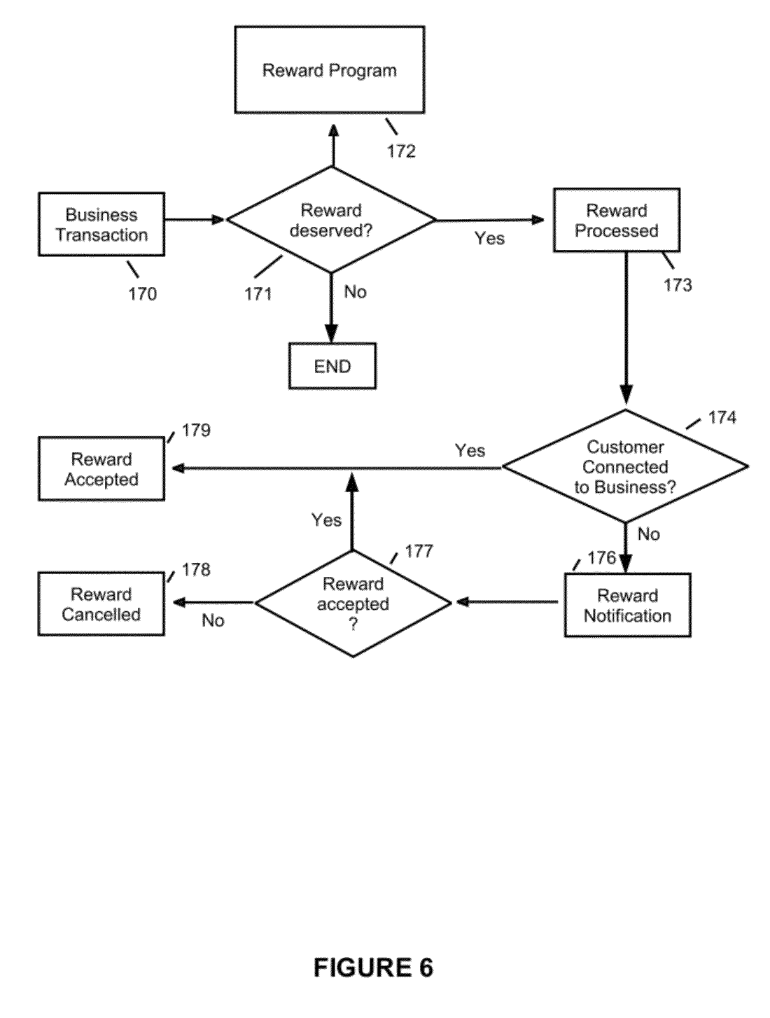

With a rewards program, the business can award its customers rewards. For example, in embodiments, a business may award its customers rewards according to the steps in FIG. 6. In the depicted example, when a business transaction has occurred 170, the business can determine if a reward is deserved by checking the reward program 172. Alternatively, the rewards system platform may be linked to the business's transaction system and may automatically determine whether rewards are due according to rules set by the business, the system, the customer, or others. If a reward is deserved, the reward granting can be processed. If the customer is connected to the business, the reward may automatically be accepted 179. If the customer is not yet connected to the business, he may receive a notification about the reward 176, and he may be prompted to either accept or reject the reward 177.

In embodiments, users that accept a reward and become a customer of the business are stored, for example, in the customers table 316 in FIG. 20. In embodiments, rewards that are processed by a business are stored, for example, in the earning transactions table 317 in FIG. 20.

It shall be noted that the platform system creates connections between businesses and customers. FIG. 9 illustrates that this process for accepting rewards creates electronic connections 210 between businesses 120 and their customers 121. These connections can be used by the businesses for many purposes, such as to message their customers through the reward system platform and to send them alerts. In embodiments, additional connections for businesses, customers, or both may be formed and used via the platform and/or via one or more other networking services. For example, in embodiments, a business or customer may link to a Facebook account.

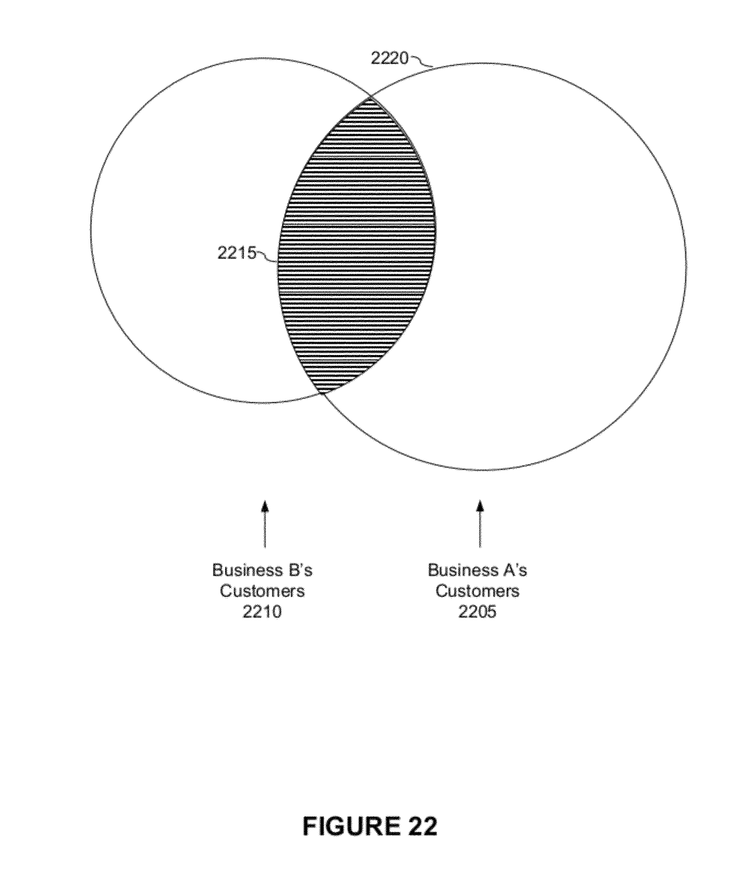

These known connections can provide valuable information for businesses and customers. This information may be used for marketing or networking. For example, some of the interactions that can be facilitated because of the data gathered by the rewards systems includes, but is not limited to: (1) businesses cross-marketing of their customer based upon location, customer preferences, sales, complementary offers, etc.; (2) customers sharing with their friends based upon preferences, locations, recommendations, etc.; (3) collaborative business reward programs; and (4) collaborative customer rewards programs. Consider, by way of illustration and not limitation, the example depicted with reference to FIG. 22.

FIG. 22 depicts an example of a use for the connection information made available as part of the rewards system according to embodiments of the present invention. Consider, for the purpose of this illustration, business A (a coffee shop) and business B (a hair salon) that are located near each other. Business A has a list of customers that participate in a rewards program. This customer list is depicted as circle 2205 in FIG. 22. Similarly, business B has a list of customers that participate in a rewards program. This customer list is depicted as circle 2210 in FIG. 22. Via the rewards system platform, it is possible to ascertain the customers that are in common, which are show as the intersection 2215. It is also possible to ascertain who are customers of one business but not customers of the other (section 2220 and 2225). Accordingly, targeted rewards programs or offers may be sent to one or more of any of the aforementioned groups or combinations thereof. Thus, businesses may use their combined customer lists to offer goods or services. Similarly, customer may join together for rewards or to transact points.

One skilled in the art shall recognize that the rewards platform provides a plurality of ways in which consumers and business can collaborate for rewards or deals. Consider, by way of illustration and not limitation, the example that is facilitated by a rewards platform system. Eric, the owner of a pizza establishment, may send a notice to nearby businesses that they can offer his pizza as a reward. In embodiments, the rewards platform system may allow Eric to enter a distance around his business in order to identify businesses that are part of the rewards platform and may want to participate. In embodiments, the platform may identify businesses, even if not users of the rewards platform, and may invite them to join or participate. In embodiments, the rewards platform may allow messaging between business participants. Eric may indicate that he is willing to offer his pizza at a substantial discount to businesses wanting to give free pizza as a reward to their customers. Eric would like $5 for each free pizza he gives on behalf of other businesses as part of their rewards programs. In response, Sunil's Coffee Shop pairs with Eric's Pizza. Sunil's Coffee Shop says that for 200 Sunil Coffee Shop points, a customer can get a free pizza at Eric's Pizza. When a customer, John Smith, redeems a free pizza using his 200 points at Sunil's Coffee Shop, the rewards system reduces John Smith's points by 200, charges Sunil's Coffee Shop $5, and pays $5 to Eric's Pizza. In embodiments, the rewards system may charge transaction or other fees for this service. In embodiments, the rewards might be mutual or multifaceted in which several businesses offer services and goods as rewards for many other businesses, all of which may be centrally monitored and coordinated by a rewards platform system.

5. Marketplace

One of the benefits of consolidating the rewards systems from different businesses and different customers is that it allows for the creation of a marketplace in which rewards points can be transacted. Traditionally, a number of problems existed to allowing individuals and businesses to transact using reward points. First, given the dispersed nature of rewards programs, the transaction costs were far too high to make any form of transaction reasonable. Second, since there was no consistent implementation, the disparity in reward point implementation, recording, and/or redeeming made transacting rewards points impractical, if not impossible. Finally, without a marketplace, there was no viable mechanism by which those seeking to transact could find others of like interest.

Accordingly, embodiments of the current invention include providing a marketplace for allowing the transaction of rewards points. In embodiments, a web interface may be provided as part of each user's account. Thus, when a business or customer logs into their account, they may choose to enter the marketplace section of the web site. One skilled in the art shall recognize that by providing a marketplace for transacting rewards points, any of a number of transactions may occur. For example, rewards points may be auctioned, donated, offered for sale or trade, bought, sold, pooled, disaggregated, mortgaged, pawned, or otherwise conveyed between customers, businesses, or both.

Consider, by way of illustration and not limitation, the following scenario. Customer X may have accumulated rewards points with Business R while travelling in a different city. Business R may be a local operation that does not have any business locations in Customer X's hometown. Although Customer X has accumulated a significant number of points, she may not have enough points to redeem a reward. Typically, those rewards points would otherwise be wasted if Customer X does return to an area with a Business R store. However, in embodiments of the current invention, Customer X could convey those points to another who could use the points. For example, Customer Y may choose to purchase the points using money or rewards points from a business of interest to Customer X.

6. Customer Registration

FIG. 13 illustrates processes for non-users to complete customer registration to use the reward system platform according to embodiments of the present invention. In a first process, a business processes a reward 173. The reward platform system will check if the reward recipient is a registered user 240. In embodiments, if he is not a registered user, he is sent a registration invitation 241 that will prompt him to complete registration 243 and become a user 244 of the reward system platform. An embodiment of a registration invitation is illustrated in FIG. 14.

The non-user receives this invitation and may formally join the system. In embodiments, the non-user may join by selecting, such as by clicking, a link in the invitation to access the reward system platform to register. Alternatively, a non-user 242 may directly visit the reward system platform and register 243. As previously discussed, in embodiments, the non-user may complete a registration form, such as the one illustrated in FIG. 15, to become a registered user. One skilled in the art shall recognize that fewer or more fields can be used on this form.

7. Business Profiles

Users in the reward system platform can view business profiles 107 to see how they can earn rewards and redeem rewards for benefits. One embodiment of a business profile is shown in FIG. 16.

In embodiments, additional information may be provided to customers. For example, business locations may be shown so that business locations near ones used by the customer may be indicated. In embodiments, a map and/or direction may be provided. Business reviews or links to the same may also be provided. In embodiments, business patronized by friends of the customer who are also members of the rewards systems may also be indicated. In embodiments, one customer may make suggestions to their friends. In embodiments, the friends may or may not be registered users. If they are not registered users, the suggestion may include an invitation to register. In embodiments, the suggestion may include special offers for the business or businesses. In embodiments, referrals, posting reviews, and other activities may be used to earn points for customers.

8. Tracking Rewards

FIG. 17 illustrates a method for customers 121 to use one user account 290 across multiple reward programs 104 for multiple businesses 120 according to embodiments of the present invention. In embodiments, the consolidation may be achieved by tying a user's earning and redeeming transactions stored in tables 317 and 318 in FIG. 20 to the respective business in the business table 311 and the respective earning rules in table 313 and redeeming rules in table 314. The user may use one or many forms of identification (e.g. email, user name, etc.) across all of the businesses on the platform 120 but all of the forms of identification stored for the user in the Identification Methods table 320 may be tied to a single user account.

Users in the reward system platform that have accumulated rewards from multiple businesses can view their rewards from the businesses in a single location. FIG. 18 illustrates an embodiment of an interface that depicts the reward balances 262 from multiple businesses 130, which balances may be consolidated to a single interface or web page.

9. Redeeming Rewards for Benefits

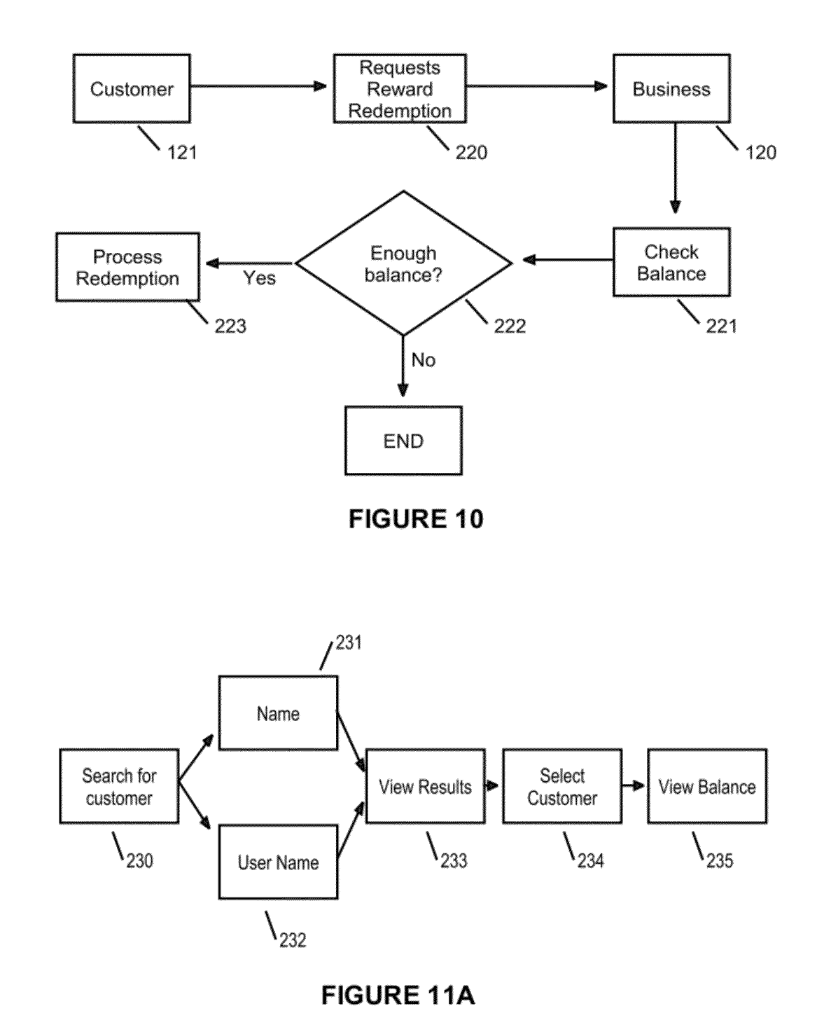

Once someone has registered and accumulated enough rewards at a business, he can redeem his rewards points for benefits. FIG. 10 illustrates a process for redeeming rewards according to embodiments of the present invention. A customer 121 requests a reward redemption 220 from a business 120. The business checks to see whether the customer has enough rewards for the redemption 221. If the customer has enough rewards 223, the redemption may be processed.

FIG. 11A shows the process a business can use to check a customer's reward balance according to embodiments of the present invention. The business may search for the customer 230 using an identifier (e.g., his name 231 or user name 232 in this embodiment) and view the results from the search 233. The business may select the customer for whom he is checking the balance 234 and then the reward system platform 100 will show the balance for that customer 235. Once rewards are redeemed, in embodiments, they are decremented from the customer's 121 balance.

In embodiment, when rewards are redeemed, the transaction is stored, for example, in the redemption transactions table 318 in FIG. 20. The customers balance is also updated in the balances table 319.

10. User Verification

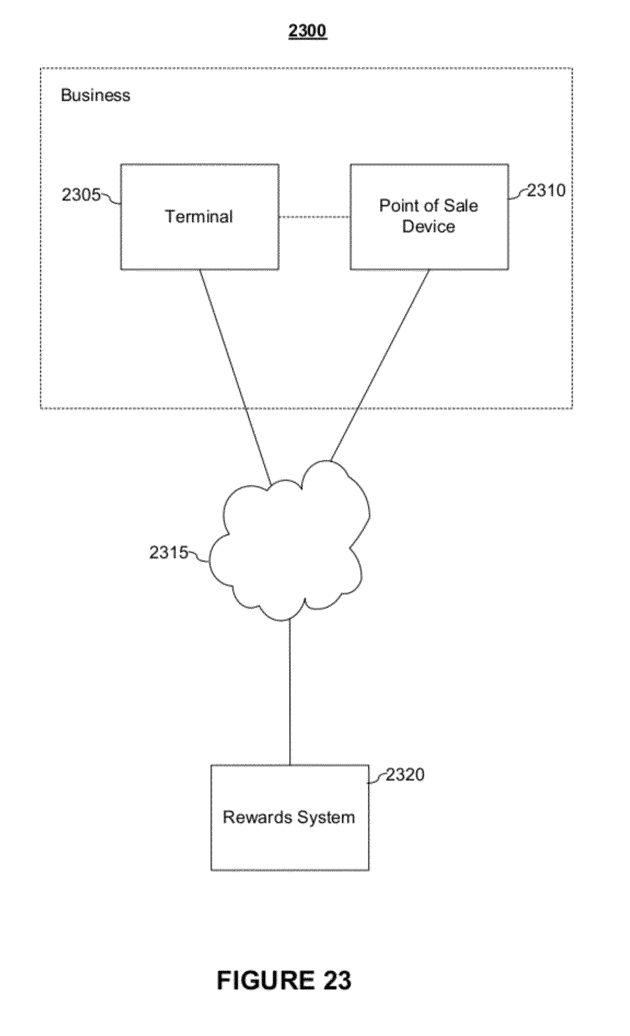

In embodiments, a terminal or kiosk device may be located at a participating business to allow users to record participation at the business. FIG. 23 depicts an embodiment of a configuration in which a terminal is provided to allow a user to record a business visit according to embodiments of the current invention. For example, in embodiments, a computer terminal, such as iPad manufactured by Apple Corporation of Sunnyvale, Calif., although other terminal devices may be used and no particular terminal device is critical to the current invention. The terminal may be located near a check-out station or a customer service location, although it shall be noted that the terminal may be located anywhere at the business location. In embodiments, the terminal may connect to the rewards system platform. Alternatively or in addition, the terminal may connect to, or integrated with, a point of sale system at the business.

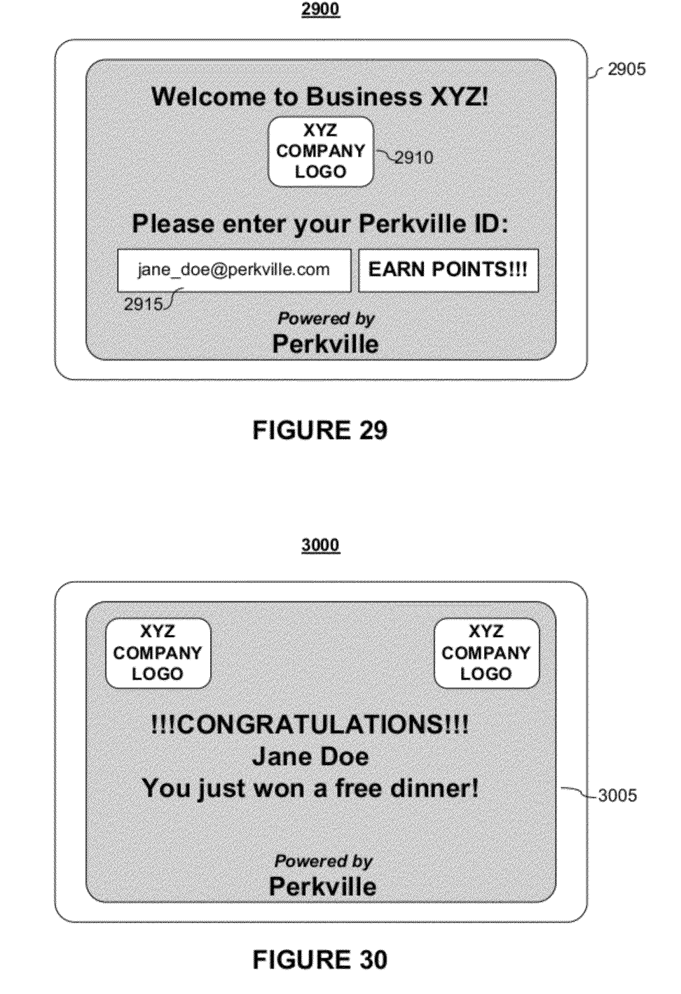

When a customer visits the business location, the customer can enter an identifier that uniquely identifies that customer, such as a customer ID, an email address, a telephone number, and the like. In embodiments, entry of the identifier may be via one or more input devices. Entry may include optical scanning, magnetic scanning, touch pad entry, key pad entry, camera image selection. The input devices may include using the camera to scan. In embodiments, biometrics, such as eye, face, or fingerprint, may be used to identify the customer. FIG. 29 depicts an embodiment of a display 2905 in which a user may record a business visit by entering an identifier 2915, such as an email address, into a terminal according to embodiments of the current invention. It shall be noted that another advantage of such an embodiment for registering user visits means that users who purchase with cash will also provide record for businesses, which typically they would not have. That is, previously, they may record the cash transaction but would likely not know who the customer was for that transaction. Here, the customer records the visit regardless of the payment method.

In embodiments, the display can be customized for the business at which it is located. Accordingly, in embodiments, the display may include the business name and/or logo 2910, and the display may be configured with a color scheme or otherwise customized by the business. In embodiments, the display may also present information to users and other customers at the location. For example, a portion of the display may provide information related to the business goods and services, special offers, etc.

In embodiments, a customer may enter his or her identifier simply for visiting the business location regardless of the whether or not a purchase was made. Thus, the business can engender customer loyalty and patronage beyond just linked to commercial transactions. In embodiments, the business may enter or record the visit for verification purposes.

### D. Simplified and Secure User Entry

Aspects of the current inventions involve making it easier for a user to register a visit to an establishment, such as for a rewards program, while maintaining a level of privacy. Developing any successful rewards program involves making interactions with customers easy for the customers. Thus, according to embodiments of the present invention, a user may record patronage by entering a unique identifier, such as an email address. It shall be noted that the systems and methods disclosed herein may be used for other purposes besides rewards programs and may also be adapted for use with other identifiers besides email addresses.

In embodiments, the simplified entry makes it easier and faster for someone to type in their email address. By making it easier to enter an email address, more users are more likely do it participate. In embodiments, a selected set of email address domain names are displayed as soon as the “@” symbol is typed, from which the user can select or narrow the options based on what the user continues to type.

1. Exemplary System Embodiments

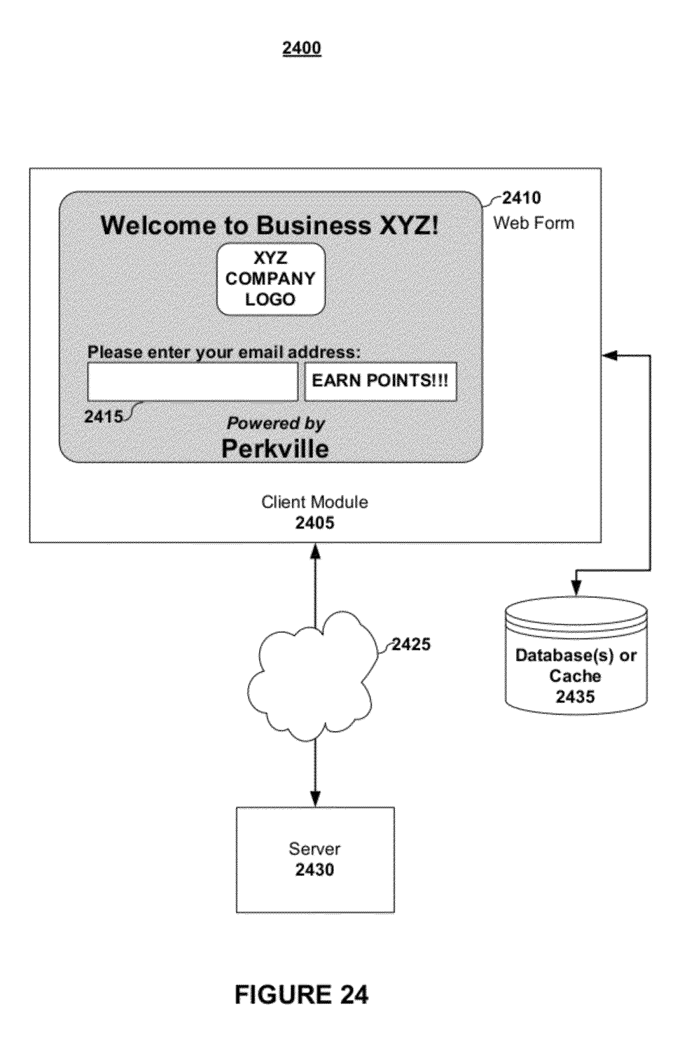

Embodiments of the current inventions for simplified user entry may be used with embodiments of a rewards system, such as those provided herein; however, one skilled in the art shall recognize its general applicability for other uses and systems. In embodiments, a terminal or kiosk device may be located at a participating business to allow users to record participation at the business. FIG. 24 depicts an embodiment of a configuration in which a terminal is provided to allow a user to record a business visit according to embodiments of the current invention. In embodiments, a computer terminal, such as iPad manufactured by Apple Corporation of Sunnyvale, Calif., although other terminal devices may be used and no particular terminal device is critical to the current invention, is located at a business. The terminal may be located near a check-out station or a customer service location, although it shall be noted that the terminal may be located anywhere at or near the business location.

FIG. 24 depicts an embodiment of a configuration in which a terminal or client module 2405 is provided to allow a user to record a visit according to embodiments of the present invention. In embodiments, the client 2405 connects, directly or indirectly, such as via the Internet 2425, to a server 2430 that may operate or control a rewards system platform. As illustrated in FIG. 24, a database or local cache 2435 may be connected to or accessible to the client 2405. In embodiments, the database or local cache 2435 may be part of, or integrated with, the client 2405. Alternatively or in addition, the terminal may connect to a point-of-sale system (not shown) at the business that connects to the rewards system platform. When a customer visits the business location, the customer can enter an identifier that uniquely identifies that customer, such as an email address. In embodiments, entry of the identifier may be via one or more input devices.

FIG. 24 also depicts a display of a form 2410 in which a user may record a business visit by entering an identifier, such as an email address, into a designated user interface entry 2415 in the display according to embodiments of the present invention. It shall be noted that another advantage of such an embodiment for registering user visits means that users who purchase with cash will also provide record for businesses, which typically they would not have. That is, previously, they may record the cash transaction but would likely not know who the customer was for that transaction. Here, the customer records the visit regardless of the payment method. In embodiments, a customer may enter his or her identifier simply for visiting the business location regardless of the whether or not a purchase was made. Thus, the business can engender customer loyalty and patronage beyond just those linked to commercial transactions.

2. Exemplary Method Embodiments

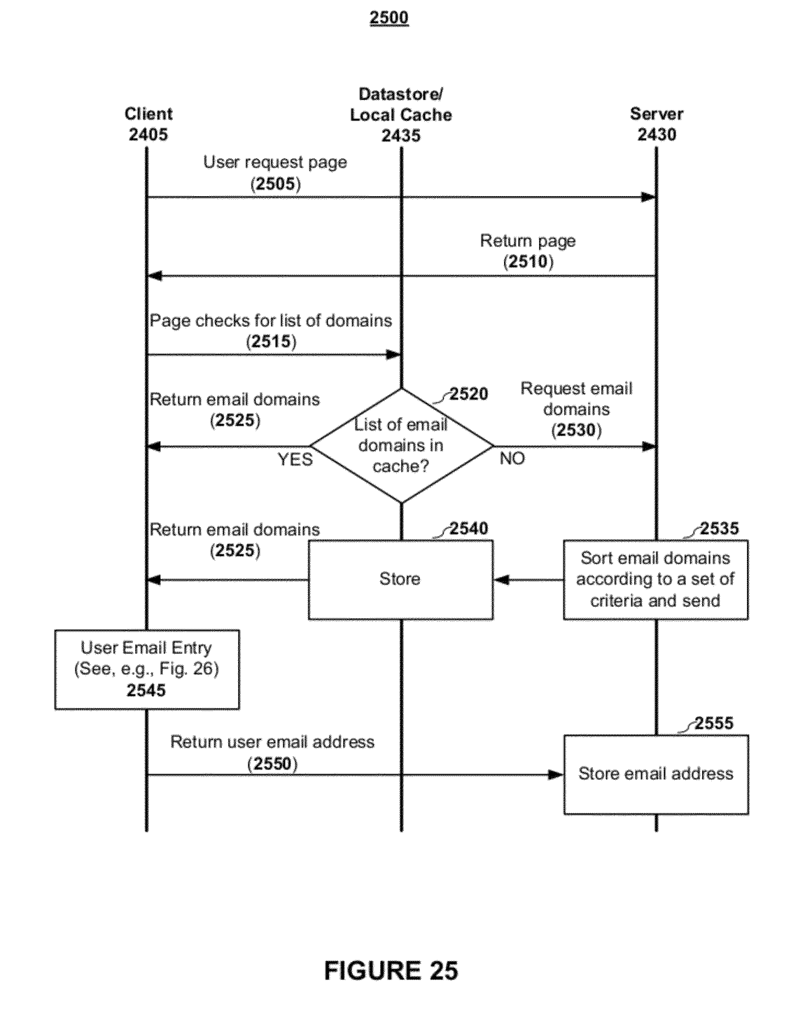

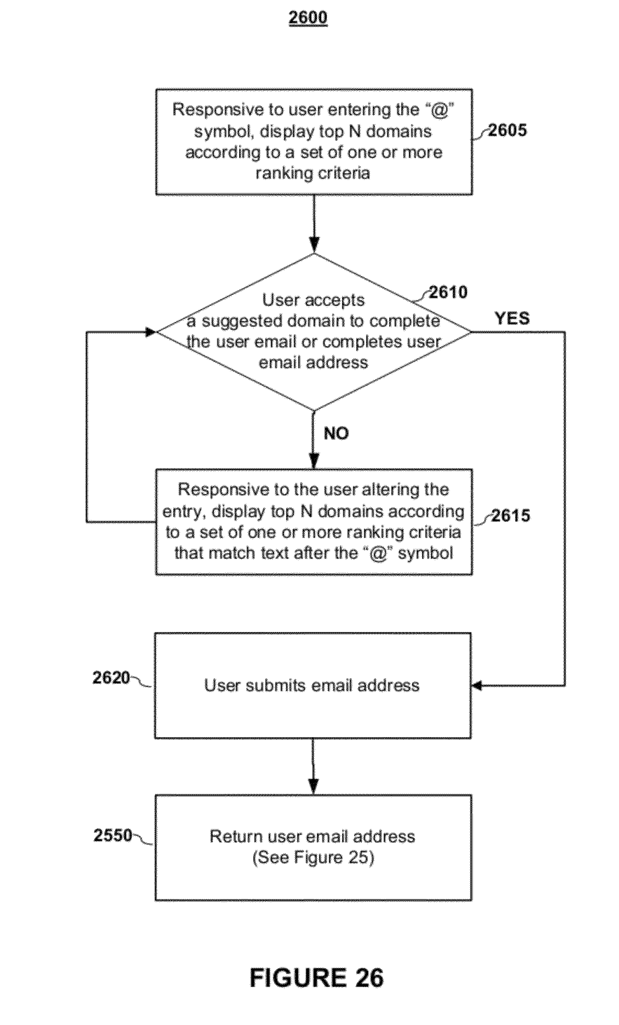

FIG. 25 depicts system interactions for providing simplified user email entry according to embodiments of the present invention. In embodiments, a user, via the client system 2405, requests (2505) the web form. The server 2430 receives the request and returns (2510) the page to the client to render. In embodiments, as part of loading the page at the client, the client checks (2515) a datastore or local cache (2435) for a list of domains. In embodiments, the datastore is local to the client, which has the benefit of reducing delay caused by any slow network connections to a remote datastore or to the server. However, one skilled in the art shall recognize that the functions of the local cache in the current method may, in alternatives, be performed by the server or by a remote datastore.

In embodiments, a check is performed (2520) to determine whether the local cache contains a list of email domains. If the local cache (2435) does not have a list of domains, a request (2530) is dispatched to the server to obtain a list of domains. The server receives the request and returns the list of domains that may be stored (2540) in the local cache and made available (2525) to the client system 2405. In embodiments, the server may sort (2535) the email domains according to one or more criteria prior to sending the email domain list. The criteria may include domains specific to the requesting location, popularity of the domains, popularity according to time of day, etc. One skilled in the art shall recognize a number of different metrics/criteria or combinations thereof that may be used. In embodiments, one or more sorted lists may be returned. That is, the emails lists may be sorted according to different metrics/criteria. For example, one list may be all domains listed alphanumerically; another list may be the most used domains, etc. In embodiments, the raw email list may be provided and the sorting may be performed by the client or datastore. In embodiments, the domain list may include a set of associated data that can be used for sorting.

In embodiments, even if the local cache has a list of email domains, if it has not been updated within a set time period, an updated email list may be requested (2530) from the server.

In embodiments, if the list of domains is at the local cache (2435), the local cache makes (2525) the email domains available to the client system 2405. As noted previously, a benefit of having the emails at the local cache is to reduce delays required to make request to and to receive responses from the server. Users tend to be annoyed by even slight time delays. Accordingly, by reducing the possibilities of time delays, the user experience can be enhanced. However, as previously noted, given current and increasing bandwidth capabilities, requests from the client may be made to the server without noticeable delay to the user.

With a list of email domains, users can be assisted in entering (2545) their email addresses. Examples of methods for assisting a user in the entry of an email are depicted in FIG. 26 and are described in more detail below. In embodiments, a user's email address is returned (2550) to the server to record (2555) a visit and garner reward points.

FIG. 26 depicts a method for assisting a user in entering his or her email address according to embodiments of the present inventions. In embodiments, a user may enter his or her identifier for visiting an establishment by entering his or her email address into a form displayed on a client terminal. In embodiments, the form monitors the key strokes as the user types. Responsive to the user entering (2605) the “@” symbol, the client accesses from the local cache the top N domains according to a set of ranking criteria. The set of ranking criteria may be one or more criteria. In embodiments, the initial listings of domains may be the top domains at that location for that establishment.

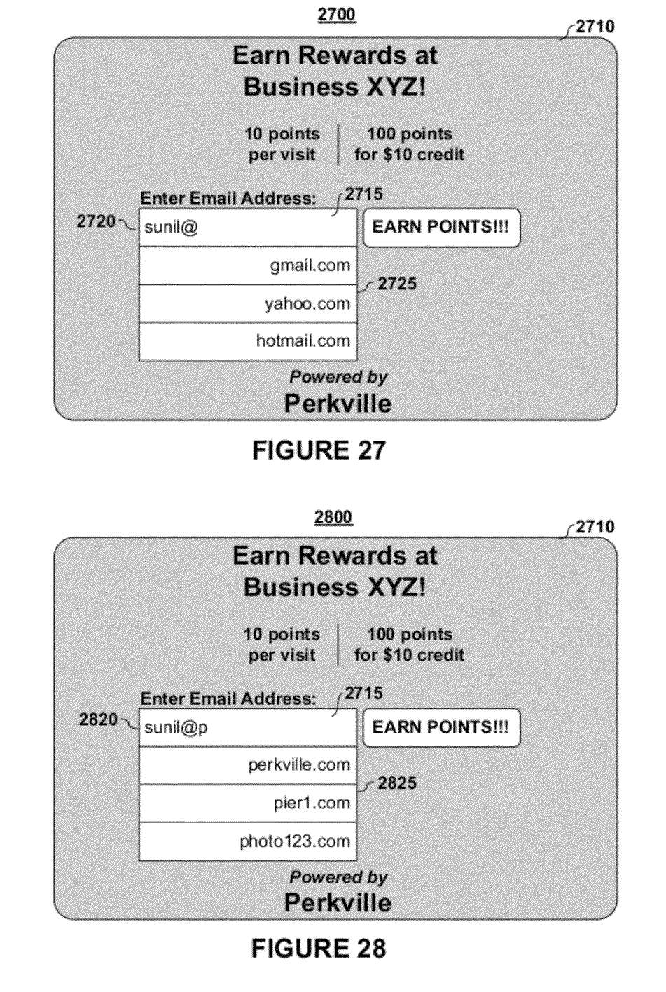

For purposes of illustration and not limitation, FIG. 27 depicts an example display with a user entry according to embodiments of the present invention. As shown in FIG. 27, the display 2710 presents an interface 2715 in which a user can enter an email address. In the depicted example, the user has entered “sunil@” 2720. Once the user has entered the “@” symbol, the display, or at least a portion of it, is updated (2605) to include a listing of domains. In the depicted example in FIG. 27, three domains 2725 are listed according to frequency of usage at that time of day at that location.

If one of those domains completes the user's email address, the user may accept (2610) one of the suggested domain 2725 by selecting it. In embodiments, the user may select it by using an input device, such as a touch screen, mouse, keypad, or other input device. For example, in embodiments, the user may use the arrow keys to change a highlighted suggested domain for selection. In embodiments, when a suggestion is selected, it completes the email address and submit it so that the user does not have to hit the enter key or the earn points button. The selected email address is submitted (2620) and returned (2550, FIG. 25) to the server for recording.

If one of those domains does not complete (2610) the user's email address, the user continues to type. In embodiments, responsive to the user altering the entry, the display presents (2615) an updated set of the top N domains according to a ranking criteria that match text after the “@” symbol. In embodiments, the ranking criteria may be the top domains that match the text after the “@” symbol. For purposes of illustration and not limitation, FIG. 28 depicts an example display with an updated user entry according to embodiments of the present invention.

As shown in FIG. 28, the user typed the letter “p” after the “@” symbol. This indicated that the domains shown in FIG. 27 did not complete the user's email address. The client system then takes the new information, in this case the letter “p”, and displays 2825 an updated set of email domains. In embodiments, the only criterion may be the alphabetical match (in this case domains that start with “p”), but in alternative embodiments, addition criteria may be used, such as the top matching text domains that are also the most common for the location. Other example criteria include: listing domains that are associated with users that have the most rewards points; activity levels of domains; where users live relative to the input point; a user's GPS (global positioning satellite) location; reward system terminal's GPS location; etc.

It shall be noted that, in embodiments, the displayed list of domains may update responsive to any change in text after the “@” symbol. Such embodiments insure that when the user makes a change to any of the text after the “@” symbol that new, correctly matching, domains are presented as possible email domains. In embodiments, if, as the user enters text, there are no matching emails, the type ahead/suggested domains list goes away as there are no matching email domains to display.

In embodiments to further make it easier for the user to enter the domain, the top suggested domain may be a default highlighted suggestion. And, whenever the text after the “@” symbol is changed, the updated suggestion list is displayed and the default highlighted suggestion is positioned at the top of the list.

The steps 2610 and 2615 repeat until the user completes the email address either by typing it full (that is, it did not appear in the local cache) or until a suggested domain matches the user's domain and the user selects it as discussed previously. Once the email address is completed (by either fully typing it or selecting a suggested domain) and submitted (2620), it is returned (2550, FIG. 25) to the server for recording. In embodiments, the submission may be initially recorded locally and then submitted at another time or as a batch to the server.

Note that by only providing prompting aids after the user has entered the first part of the email address (the portion prior to the “@” symbol), a certain level of privacy is maintained for all users. Because the terminal or kiosk is open to the public or at least the visitors of the establishment, third parties have access to it, include other users as third parties. If the system provided a full prompt—meaning that it provides prompts for email addresses starting with the first character (or even before)—then these third parties could obtain email addresses from the system. Trolling or harvesting email addresses has become a lucrative, but often shadowy, business. Thus, by requiring the user to at least know the first portion of the email address, would-be email harvesters are thwarted in trying to extract email addresses from the terminal.

In embodiments, the client system may record usage of the type ahead/suggested domains. This information may be examined for several reasons, including but not limited to: tracking the effectiveness of the suggested domains; tracking usage of the suggested domains; tracking which metrics are best for deciding the top ones to display; changes in user compliance with the suggested domain turn off vs. turn on; etc.

### E. Gaming Aspects

Aspects of the current invention may also include adding gaming functionality to a rewards program. By implementing gaming elements, users and businesses can be further incentivized to participate in rewards or rewards-related programs.

In embodiments, a gaming element may include ranking of businesses, users, or both according to one or more criteria. For example, in embodiments, users may be ranked according to one or more of: the number of rewards points used, the number of rewards points redeemed, usage, number of business visits, number of referrals, number of reviews posted, etc. In embodiments, businesses may be ranked according to reviews, points awarded, points redeemed, customer visits, etc. In embodiments, gaming indicators may also be employed. For example, a status bar may be used to show progress of earning rewards points.

In embodiments, a gaming element may include creating games or competitions between users, businesses, or combinations thereof. In embodiments, competitions may be configured across teams of business, teams of users, or combinations thereof. For example, in embodiments, a group of users may be formed into a team that must accumulate a number of rewards points from a business or set of businesses, similar to a scavenger hunt. The first group to acquire the requisite rewards points may be offered a prize. In embodiments, the prize may include discounts on goods or services from participating businesses, free prizes, additional rewards points, or the like.

In embodiments, a gaming element may include sweepstakes, giveaways, or lottery. It shall be noted that such programs may be used to help entice new members to join, to help entice current users to participate, and to help entice businesses to participate. For example, in embodiments, a user may be asked to register business visits by recording that he or she visited the business. As discussed previously, a way in which a user can record a visit is by entering a unique identifier into a terminal at the business location. FIG. 29 depicts an embodiment of a display 2900 in which a user may record a business visit by entering 2915 an identifier, such as an email address, into a terminal according to embodiments of the present invention. As an added benefit of registering the visit, once a user records the visit, that act could operate like a lottery entry, in which the user may be selected for additional rewards. In embodiments, the selection may be delayed some amount of time or may be immediate so that just after entry at the terminal, the terminal may indicate to the user that he or she was selected as bonus winner. FIG. 30 depicts an embodiment of a display 3000 in which the user is notified 3005 of winning after having recorded her visit to a business according to embodiments of the present invention. In embodiments, the reward may be a free or discounted item or service provided by the business that the user is currently visiting or for some other business. In embodiments, the user may redeem the prize at that time or at a later date.

One skilled in the art shall recognize that a number of gaming aspects may be implemented.

### F. Improved Deal Offerings

1. Background

Companies that provide group deals, such as the daily deals of Groupon and LivingSocial, have altered local commerce. Such companies have rapidly grown by offering consumers deals for products and services from local businesses. These deals are successful for a few reasons. First, these deals are steeply discounted. Second, the recipients have a deadline to purchase the deal, which creates a sense of urgency in the buyers. And third, the recipients can purchase the deal immediately online without having to visit the local business.

Although these deals have become popular, they have some significant drawbacks for the local businesses that offer the deals. First, businesses primarily want to use such daily deals to acquire new customers. Often, these deals are at steep discounts, even possibly offered at a loss, with the hopes that new customers will be gained. However, because daily deal companies cannot distinguish between new prospects and existing customers, the deals are sold to both categories indiscriminately. As a consequence, the businesses often cannibalize their more profitable full price sales to its existing customers.

Another significant drawback to current deal programs is the unevenness of the consumer traffic. A deal is offered to all recipients at the same time. The list of recipients typically includes everyone that the deal provider has in its list, including existing customers of the business, which as mentioned above is cannibalistic to the business' profits. Note also, that the deal expires for all recipients at the same time. Because the deals are offered to all recipients at the same time, they typically bring a flood of customers within a short interval. This high volume of low or no profit traffic can overwhelm businesses and yield unintended negative consequences. For example, the overwhelmed business, unable to adequately service all the customers, may leave some customers with a poor experience. Given the prevalence of online reviews, their bad experience can have a long-reaching influence—hurting the business's short-term and long-term viability. Also, if the business is swamped with customers who are using their deals, which typically yields little or no profit for the business due to the steep discount, other consumers that would be more profitable to the business may be pushed away and go elsewhere. Those lost revenues and potentially lost customers can also be harmful to the business' long-term viability.

2. Improved Deal Platform Flow

Unlike prior deal offerings, which were offered at the same time to all people, the present invention allows for multiple offerings that can be offered at different times and to different groups of consumers. It shall be noted that although the deals can have different start and stop times, one or more deals may have the same start and/or stop times. Also, it should be noted that deal recipients may share none, partial, or complete overlap with one or more other deal offerings. It shall be noted that the some or all of the components and tables presented in these sections may be functional and/or physically integrated with other components and tables presented in this patent document.

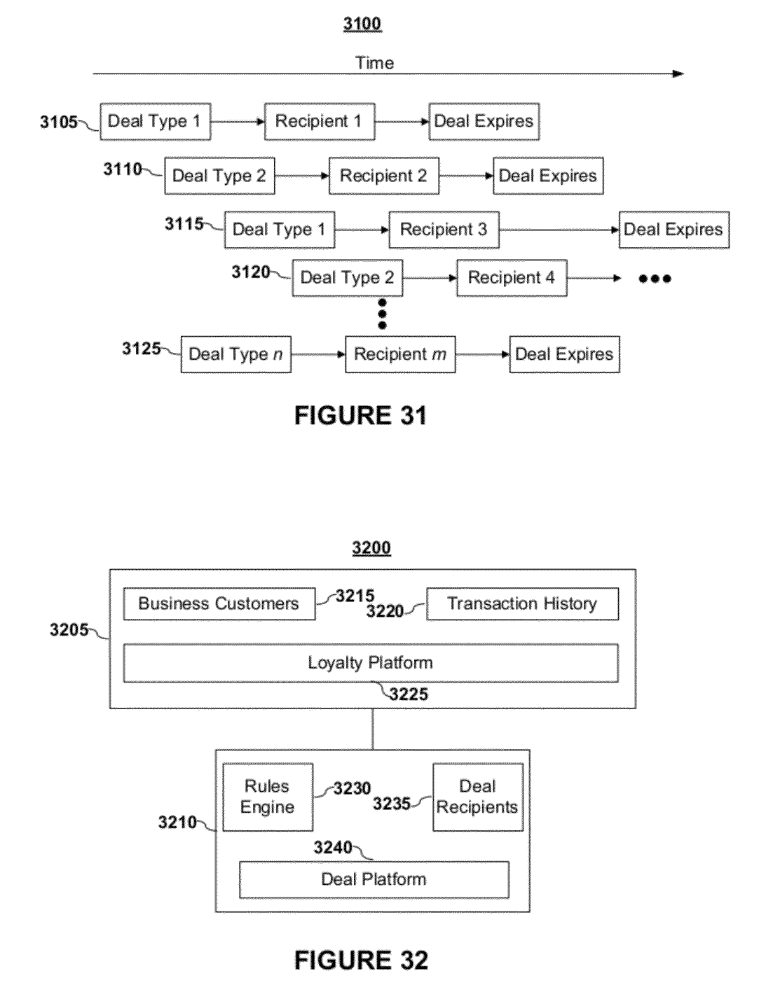

FIG. 31 illustrates, by way of example and not limitation, a set of deals offered at different times to different recipients. For example, deal 1 (3105) is offered at a first time to a first set of recipients and is set to expire at a first deal expiration time. Note that the same deal, deal 1 (3115) is also offered at another time to another set of recipients and set to expire at a different time then the first deal 1 offering (3105). Similarly, as shown in FIG. 31, there are two sets of deal 31 (3110 and 3120) that are also offered with different deal intervals and offered to different recipients.

One skilled in the art shall recognize that the deal platform of the current patent document offers several advantages of the prior approaches. For example, deals may be sent on an ongoing basis (e.g., deal n (3125)) rather than in one batch to everyone. This temporal flexibility allows a business to better load balance its offers so that it is not swamped with a large number of customers in a short time period. Also, the flexibility allows the deals to have different expiration times. Another benefit is that each recipient or type of recipient can be sent a specific type of deal. Thus, deals can be highly customized and targeted to individuals and groups and the expiration date can be specified for each recipient rather than be the same for all recipients.

3. Combined Loyalty or Rewards System with Deal System

This ability to target consumers integrates beneficially with business loyalty systems and programs. FIG. 32 depicts an embodiment of a combined loyalty platform system and deal platform system 3200 according to embodiments of the present invention. FIG. 32 depicts a loyalty system 3205 communicatively coupled to a deal platform system 3210. In the depicted example, the loyalty system comprises one or more databases of customers 3215 and transaction history 3220, which interface with a loyalty platform 3225. In embodiments, the loyalty platform may comprise a rules engine that monitors the transaction history of business customers and grants rewards according to set rules. In embodiments, the loyalty platform may also be used in tracking and granting the redemption of customer rewards. Loyalty system 3205 may comprise one or more of the systems and methods disclosed in the current patent document. It shall be noted, however, that other systems may also be used.

Also depicted in FIG. 32 is a deal system 3210. In the depicted example, deal system 3210 comprises rule engine 3230, one or more databases of deal recipients 3235, and a deal platform 3240. The deal rule engine module 3230 comprises sets of rules for one or more businesses related to how deals are formed, when the deals expire, special terms, and so forth. The rule engine 3230 interfaces with the deal recipients 3235 database to identify who should receive offers and when those offers should be sent. In embodiments, the system may interface with one or more datastores or tables to tracking and monitoring purposes (such as, by way of example, the database and tables presented herein) and may, alternatively or additionally, provide one or more interfaces to facilitate the creation, execution, and display of data related to promotions/deals of businesses. FIG. 32 illustrates how a customer loyalty platform and deal platform can interoperate to target specific sets of users for a deal. The loyalty platform contains each business' customers and their transaction history. In embodiments, the data may also include customer preference information. In embodiments, the system can leverage this data to target specific types of deals to specific types of deal recipients. For example, a business might target one deal to potential customers, a different deal specifically catered to existing customers, and yet another deal targeted to try to win back customers of the business that have not transacted with the business in some defined time period. In embodiments, a promotion may be suggested by one or more recipients that the business may then execute. In embodiments, a promotion may require the collaboration of two or more recipients. In embodiments, the collaboration may be facilitated via the system, such as messaging between recipients, group purchasing, group purchasing among different businesses that have collaborated for a promotion, and the like. In embodiments, the system may, according to rules set by a business or businesses, monitor at specified periods for data that prompt a deal being offered to specific contacts, such as a rewarding a referral or enticing someone who received a recommendation/referral to use the business. In embodiments, more than one business may utilize the system thereby allowing cross-business or combined deals to be offered to one or more of the businesses' customers. In embodiments, the cross-promotion activities may be done by the centralized deal system without the need of the businesses to share or have access to the customer contact information. In embodiments, the rules engine may receive input from one or more businesses via one or more user interfaces provided by the system to set various rules to execute the promotions, such as the examples listed herein.

4. Examples of Types of Ongoing Deals

It shall be noted that the embodiments of the present invention may use a number of types of ongoing deals. Consider, by way of illustration and not limitation, the following types of deals: (a) deals specifically for people that are referred to the business; (b) deals for existing customers of the business; (c) deals for existing customers of the business that have not been frequented the business in some time period; (d) deals for non-customers/prospective customers only in an effort to turn them into customers; (e) deals for specific merchandise or services; (f) deals for specific time frames; (g) deals coordinated with other businesses; and (h) deals coordinated between or among recipients.

One skilled in the art shall recognize that the flexibility offered by the current invention allows for a host of deals by enabling any of a number of configurations of businesses, recipients, products, services, start times, stop times, and the so forth. This flexibility allows for immense creativity and opportunity in forming general and targeted deals, which previously was unavailable. It shall also be noted that, in embodiments, the deal system supports ongoing deals by tracking one or more factors, such as (by way of example and not limitation): recipient, when the deal expires in relation to when a recipient received a deal, and so forth—rather than just having the deal end on a specific day for all recipients.

5. Drafting a Deal

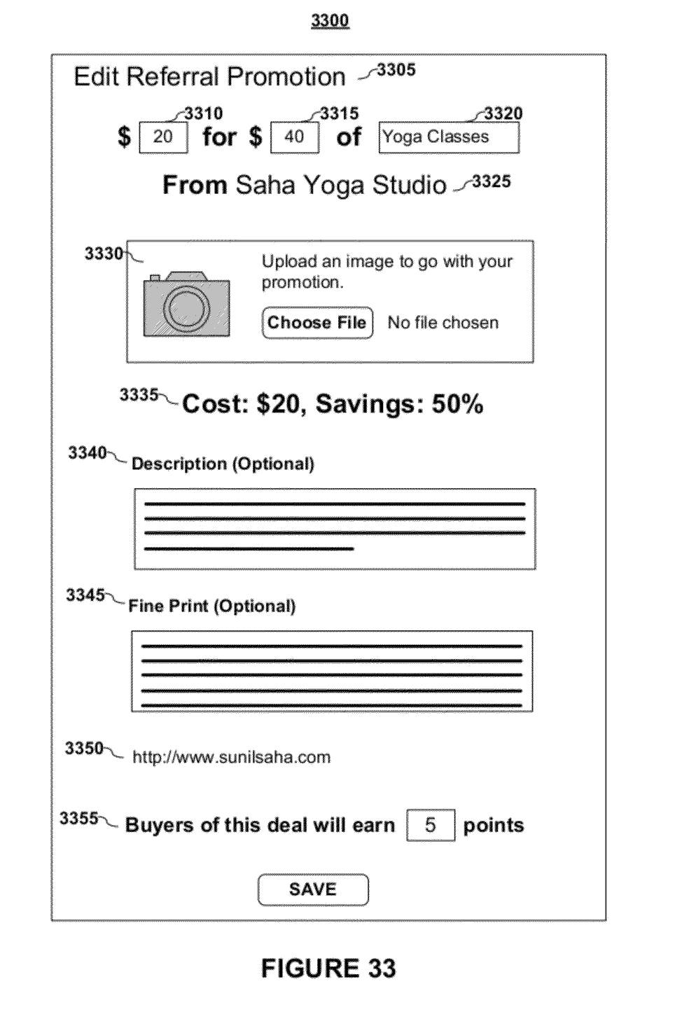

In embodiments, the deal system 3210 in FIG. 32 may be used to form a deal. In embodiments, the deal system 3210 provides an interface to a user to draft the deal. In embodiments, the deal data may include the following: (1) business offering the deal; (2) price of the deal; (3) value of the deal; (4) item or service which the deal is for; (5) an image for the deal; (6) deal description; and (7) additional “fine print” information, such as deal specific terms, regulator or legal disclaimers. FIG. 33 depicts an example of an interface that may be used to create a deal according to embodiments of the present invention.

The example interface 3300 shown in FIG. 33 is of a referral promotion 3305, meaning that the targeted recipients may be referred prospects—the hope being that the current deal will entice prospects referred to the business. The interface embodiment allows for the entry of a deal price ($20) 3310 and the original price ($40) 3315 for a service 3320, which is yoga classes in this example. The interface clearly indicates the business 3325 for which this deal rule is being formed, in this case Saha Yoga Studio. In embodiments, the interface allows a user to select and upload 3330 one or more images or files to accompany the deal announcement. In embodiments, the interface displays the offering value 3335. In embodiments, one or more portions of the interface receive a description 3340 about the deal and any associated fine print information, such as legal disclaimers. In embodiments, the interface may displace additional identifying information, such as Internet and/or physical address, which may or may not be included in the deal announcement. Finally, in the depict example, the deal may also be tied with a loyalty system or rewards system in which a rewards rule is also formed in granting rewards for a successful purchase. In the depicted example, a successful purchase will earn the purchaser 5 rewards points 3355. In embodiments, additional rules may also be set, such as trigger conditions, conditions related to potential recipients of the promotion, variability of start or stop of the promotion, schedule for checking whether a trigger condition or conditions have been met, and other such conditions. It shall be noted that other rules/conditions may be applied and that other interface configurations may be used, including splitting the interface into a number of different screens or other means, which all shall be considered part of the current invention.

6. Sending Deals

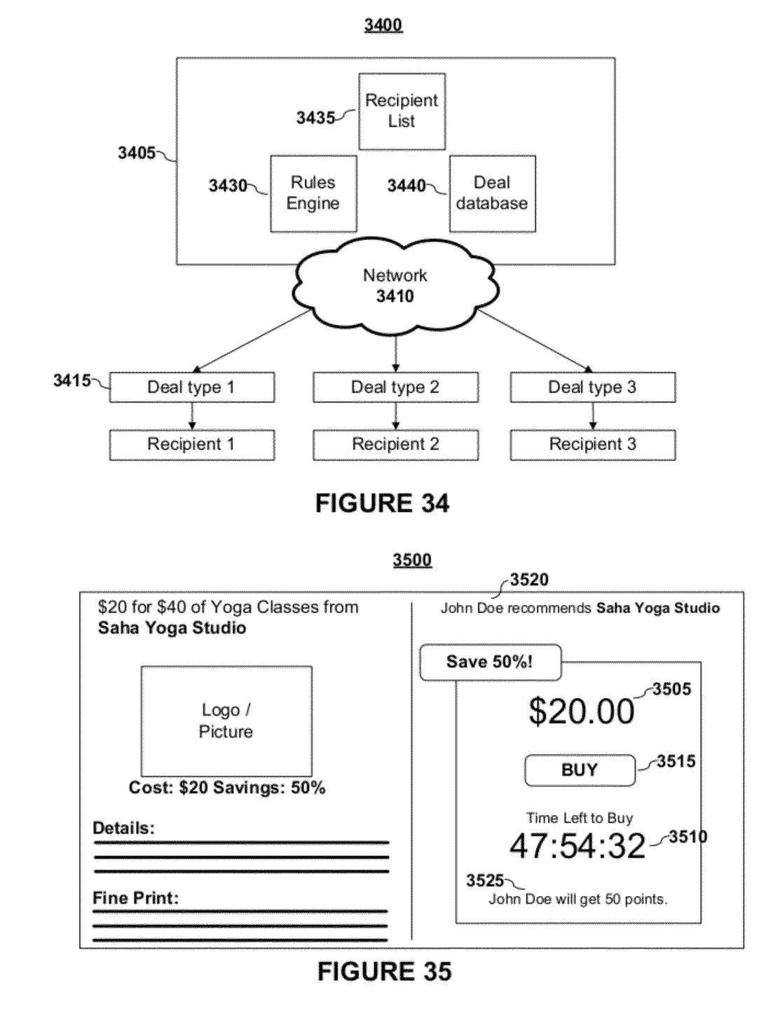

In embodiments, the deal platform may include a promotions distributor for facilitating communications with recipients and other third parties. In embodiments, the distributor may employ one or more third party services for mass distribution of promotions or employ cloud resources for that purposes to reduce overhead costs and to allow for flexibility in offering distribution channels. Systems currently exist that allow for the transmission of data to recipients. For example, a number of email notification systems exist that are used for distributing messages. One skilled in the art shall recognize that one or more of these systems may be used with the deal system to communicate promotions or promotion information. For purposes of illustration and not limitation, FIG. 34 depicts an embodiment of a deal system for sending deal announcements to recipients according to embodiments of the present invention.

Depicted in FIG. 34 is a deal platform system 3405 that comprises three principal components that operate to determine which deals to send to which recipients. The system 3405 comprises one or more databases of deals 3440; a rules engine 3430 with the rules associated with each type of deal; and one or more databases of potential recipients or contacts 3435. It shall be note that system 3405 may be the same as or utilize components from the deal system 3210 in FIG. 32. In embodiments, the rules engine 3430 is checked to see which recipients should receive which deal or deals in the deal database. The system 3405 then sends or coordinates to be sent, each recipient in the recipient database 3435 the specific deal he, she, or it should receive based on the rules engine. In embodiments, the system 3405 is communicatively coupled to a network 3410, such as the Internet, for transmitting the deal announcements to the intended recipients, e.g., Deal 1 (3415) to Recipient 1. As mentioned above, the system may transmit the deals via one or more third-party messaging services.

FIG. 35 depicts an example of an email deal announcement sent to a recipient according to embodiments of the present invention. The depicted example is based upon the deal submitted as shown in the interface example in FIG. 33. In the depicted embodiment, the announcement includes information about the deal, including the time left 3510 for the recipient to accept the deal. This time 3510 and the price 3505 may be specific to this recipient. In embodiments, the recipient can accept the deal by selecting a button, such as a “Buy” button 3515, although no particular method for accepting the deal is critical to the present invention. Also, since this example was a referral deal, in embodiments, the deal also indicates who 3520 made the referral and the number of points the user that submitted the referral will receive (3525).

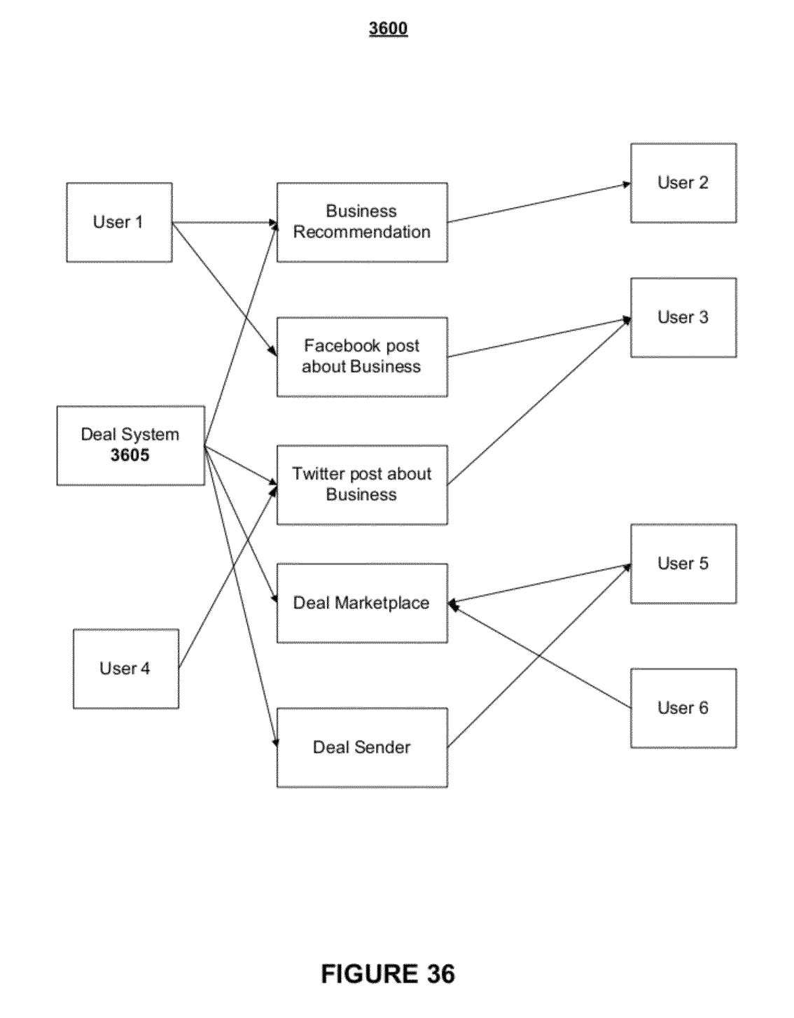

It shall be noted that the mechanism for sending deal announcements are manifold, including email, text messages, faxes, phone calls, and social media, such as Facebook and Twitter. FIG. 36 depicts examples of communication means and interactions between these communication means, users/recipients, and a deal system according to embodiments of the present invention. In embodiments, the improved deal system of the present document tracks one or more factors, such as (by way of example and not limitation): what user or system originally sent the deal, how it was transmitted, when it was sent, who is allowed to view/accept the deal, and so forth. This configuration enables each deal recipient to receive/view/accept the deals meant for them according to the rules for each deal, as well as track when the deal should expire for that specific user or deal regardless of how the deal is transmitted.

In embodiments, the deal system may distribute deals in many ways. For example, the deal system may periodically send deals to recipients. In embodiments, the deal system may send deals to recipients based on a trigger event, such as a user recommending a business that is providing a deal to another user. In embodiments, the deal system may provide a deal marketplace where users may purchase deals, which is explained in more detail in the following section.

7. Deal Eligibility in Marketplace

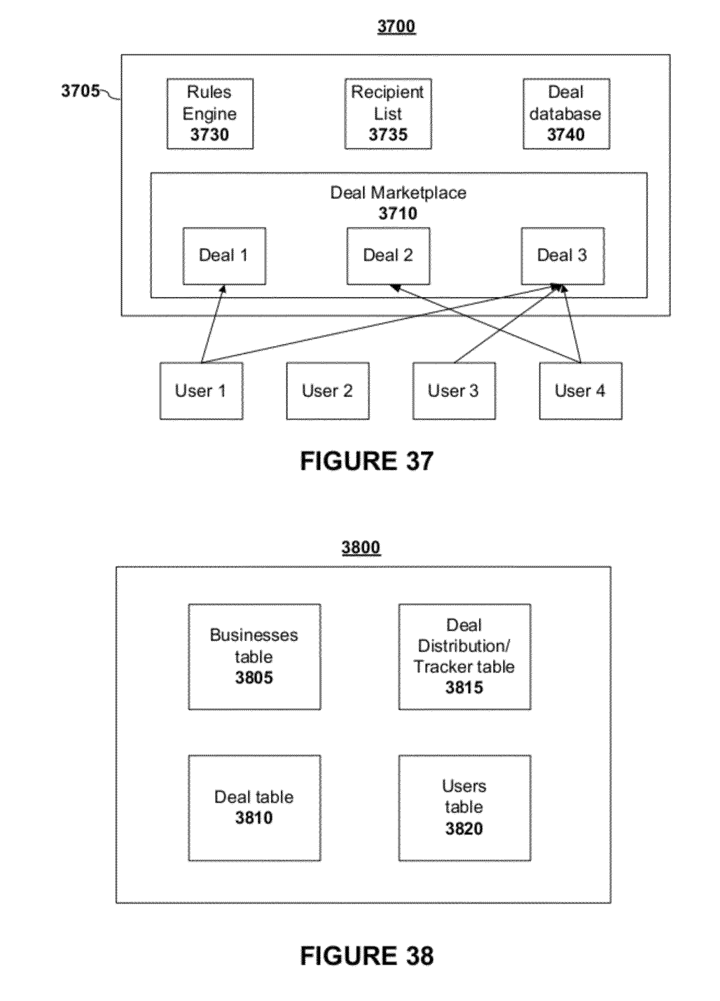

Embodiments of the deal system may also be used to host a deal marketplace where users can browse deals. In embodiments, based upon a user's login or other identifier, the deal system may hide and show deals to the user based on the rules associated with the deal and/or user. In embodiments, the rule may include, by way of example and not limitation: hiding deals for prospective customers from existing customers of a business; only showing a win-back deal to a customer that has frequented a business in the set time period; and showing a customer appreciation deal to customers that meet the criteria set up by the business. In embodiments, the deal system may also prevent a user from buying a deal if it is found that he is ineligible to purchase the deal, for example, if he inadvertently stumbled upon the deal in a public setting. FIG. 37 depicts an example of an interaction between users and a deal system 3705 that includes a deal marketplace 3710. FIG. 37 illustrates that different users can and cannot see different deals in the deal marketplace 3710 based on the rules set up for each deal according to embodiments of the present invention. For example, User 1 can see Deals 1 and 3 but not Deal 2. User 2 can access none of the current deals. User 3 can access only Deal 4, and User 4 can access only Deals 2 and 3.

8. Database

Turning now to FIG. 38, depicted is a database structure to facilitate the deal platform according to embodiments of the present invention. In embodiments, the database structure comprises: a businesses table 3805 containing all of the businesses on the platform, a deal table 3810, a deal distribution table 3815, and a users table 3820. In embodiments, one or more additional databases or tables may be included. For example, a promotion purchase tracking table (not shown) may be included that tracks information related to the purchase of programs, such as which recipients purchased what items—user ID, deal ID, date purchased, invoice ID, and the like. Also, in embodiments, a voucher table (not shown) may be included that tracks what vouchers recipients have and the state of those vouchers (e.g., used, unused, current, expired, and so forth).

In embodiments, the businesses table is communicatively connected to the deal table, which contains the deals each business is offering. In embodiments, the deal table contains at least some of the following fields: Business ID, Deal type (e.g. referral, win back, etc.), Deal ID, location ID, Title, User cost, Actual value, Description, Details, Fine print, Time limit, graphics or images, and the like. Of course, other data may be included. In embodiments, each time a business modifies a deal, a new deal ID is assigned to the new version and a new entry is added to this table.

In embodiments, when a deal is sent to a user, the information is logged in the deal distribution table 3815. In embodiments, the deal distribution tracker table may include at least some of the following fields: Deal ID; Deal distributor ID; business sender ID, Deal receiver ID; distribution type (i.e., method or methods for distributing the incentive program announcement, such as email, text, etc.), created date or dates, expiration date or dates, and date sent. As with the deal table, other data may be included. In embodiments, the Deal ID in the deal distribution table ensures that the recipient sees the right version of the deal. Consider the following example, which illustrates this point.

Assume that Business X creates a “Referral Deal” on 1 Jan. 2011. User A refers User B to Business X on 2 Jan. 2011, enabling User B to buy the Referral Deal until 4 Jan. 2011. On 3 Jan. 2011, Business X chooses to modify its “Referral Deal” before User B has purchased it. In embodiments, the deal system keeps track of what was offered, when, and to whom. Thus, User B still sees the original Referral Deal sent to him even though Business X changed the Referral Deal because the deal distribution table knows which version User B received. In embodiments, the date_sent field keeps track of when the deal was sent to the specific user so that his deadline can be properly tracked. It should be noted that, in embodiments, the date_sent field associated with both the Deal ID and the recipient are used to keep track of when the deal should expire for the user, which is unlike daily deal sites which have only a single expiration date for all recipients. Thus, the deal system allows a business to have multiple contemporaneous offers and is able to correctly track and honor each of them. One skilled in the art shall recognize other benefits of the deal system.

### G. Additional Embodiments

There are various alternatives with regards to how customers and entities may interact with the reward system platform. FIG. 21 illustrates some of these such as a mobile phone application 330, mobile phone browser 331, kiosk 332, or a point of sale system 333. One skilled in the art shall recognize that a plurality of means exist to interact, which may be employed.

One skilled in the art shall recognize that there are various alternatives with regards to the types of reward program rules that can be used. The behaviors rewarded, reward tracking and benefits can vary. Customers may be rewarded for: purchasing products or services, visiting the business, promoting the business, referring friends and colleagues. In embodiments, rewards may be tracked using a points-based system, non-points-based system, or both. In embodiments, level rewards can also be used such as the gold, silver, and platinum levels used by many airlines.

In embodiments, benefits can also vary. Benefits can be in the form of points, priority over other customers, free or discounted upgrades, free or discounted products, free or discounted services, refunds, etc.

One skilled in the art shall recognize that embodiments of the reward system platform provides an easy mechanism for customers to acquire rewards using one account, to track their rewards across multiple businesses in a single location and provides a platform where businesses can quickly and easily have their own rewards program.

### H. Computing System Implementations

In embodiments, one or more computing system may be configured to perform one or more of the methods, functions, and/or operations presented herein. Systems that implement at least one or more of the methods, functions, and/or operations described herein may comprise an application or applications operating on at least one computing system. The computing system may comprise one or more computers and one or more databases. The computer system may be a single system, a distributed system, a cloud-based computer system, or a combination thereof.

It shall be noted that the present invention may be implemented in any instruction-execution/computing device or system capable of processing data, including, without limitation phones, laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

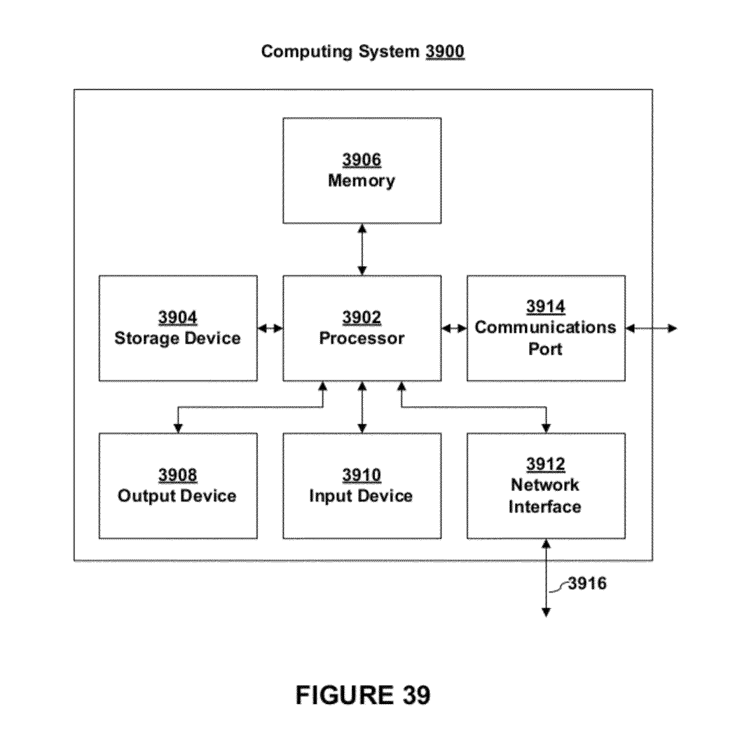

FIG. 39 depicts a functional block diagram of an embodiment of an instruction-execution/computing device 3900 that may implement or embody embodiments of the present invention, including without limitation a client and a server. As illustrated in FIG. 39, a processor 3902 executes software instructions and interacts with other system components. In an embodiment, processor 3902 may be a general purpose processor such as (by way of example and not limitation) an AMD processor, an INTEL processor, a SUN MICROSYSTEMS processor, or a POWERPC compatible-CPU, or the processor may be an application specific processor or processors. A storage device 3904, coupled to processor 3902, provides long-term storage of data and software programs. Storage device 3904 may be a hard disk drive and/or another device capable of storing data, such as a magnetic or optical media (e.g., diskettes, tapes, compact disk, DVD, and the like) drive or a solid-state memory device. Storage device 3904 may hold programs, instructions, and/or data for use with processor 3902. In an embodiment, programs or instructions stored on or loaded from storage device 3904 may be loaded into memory 3906 and executed by processor 3902. In an embodiment, storage device 3904 holds programs or instructions for implementing an operating system on processor 3902. In one embodiment, possible operating systems include, but are not limited to, UNIX, AIX, LINUX, Microsoft Windows, and the Apple MAC OS. In embodiments, the operating system executes on, and controls the operation of, the computing system 3900.

An addressable memory 3906, coupled to processor 3902, may be used to store data and software instructions to be executed by processor 3902. Memory 3906 may be, for example, firmware, read only memory (ROM), flash memory, non-volatile random access memory (NVRAM), random access memory (RAM), or any combination thereof. In one embodiment, memory 3906 stores a number of software objects, otherwise known as services, utilities, components, or modules. One skilled in the art will also recognize that storage 3904 and memory 3906 may be the same items and function in both capacities. In an embodiment, one or more of the methods, functions, or operations discussed herein may be implemented as modules stored in memory 3904, 3906 and executed by processor 3902.

In an embodiment, computing system 3900 provides the ability to communicate with other devices, other networks, or both. Computing system 3900 may include one or more network interfaces or adapters 3912, 3914 to communicatively couple computing system 3900 to other networks and devices. For example, computing system 3900 may include a network interface 3912, a communications port 3914, or both, each of which are communicatively coupled to processor 3902, and which may be used to couple computing system 3900 to other computer systems, networks, and devices.

In an embodiment, computing system 3900 may include one or more output devices 3908, coupled to processor 3902, to facilitate displaying graphics and text. Output devices 3908 may include, but are not limited to, a display, LCD screen, CRT monitor, printer, touch screen, or other device for displaying information. Computing system 3900 may also include a graphics adapter (not shown) to assist in displaying information or images on output device 3908.

One or more input devices 3910, coupled to processor 3902, may be used to facilitate user input. Input device 3910 may include, but are not limited to, a pointing device, such as a mouse, trackball, or touchpad, and may also include a keyboard or keypad to input data or instructions into computing system 3900.

In an embodiment, computing system 3900 may receive input, whether through communications port 3914, network interface 3912, stored data in memory 3904/3906, or through an input device 3910, from a scanner, copier, facsimile machine, or other computing device.

In embodiments, computing system 3900 may include one or more databases, some of which may store data used and/or generated by programs or applications. In embodiments, one or more databases may be located on one or more storage devices 3904 resident within a computing system 3900. In alternate embodiments, one or more databases may be remote (i.e., not local to the computing system 3900) and share a network 3916 connection with the computing system 3900 via its network interface 3914. In various embodiments, a database may be a database that is adapted to store, update, and retrieve data in response to commands.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with a tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. At least one tangible computer-readable medium storing one or more sequences of instructions for facilitating an incentive service, wherein execution of the one or more sequences of instructions by one or more processors causes the one or more processors to perform the steps comprising:
response to a request from an establishment from a plurality of establishments registered with the incentive service, providing to the establishment one or more prompts via one or more user interfaces to assist in forming an incentive program related to the establishment, the prompts for requesting data to create at least one earning rule for earning incentive points and at least one redemption rule for redeeming earned incentive points;
responsive to receiving data from an establishment related to its incentive program, using the data to generate and store in a rules database associated with the establishment the at least one earning rule and at least one redemption rule;
response to a request from an establishment from a plurality of establishments registered with the incentive service, providing to the establishment one or more user interfaces to facilitate submission of an earnings statement which records satisfaction of at least one earning rule, the one or more user interfaces enabling the establishment to identify and select an earning rule from among the least one earning rule of the establishment and to identify, in a patron database associated with the establishment, and select a patron who satisfied the earning rule;
responsive to receiving an earnings statement from an establishment related to its incentive program, the earnings statement comprising a selected earning rule and a selected patron, incrementing, according to the selected earning rule, an account of incentive points of the patron, the account being stored in a patron database associated with the establishment; and
response to a request from an establishment from a plurality of establishments registered with the incentive service, providing to the establishment one or more user interfaces to facilitate submission of a redemption statement, the one or more user interfaces enabling an establishment to identify and select a redemption rule from among the least one redemption rule associated with the establishment and to identify in a patron database associated with the establishment and select at least one patron with an account having sufficient incentive points to satisfy the identified redemption rule.

2. The at least one tangible computer-readable medium of claim 1 further comprising:
responsive to receiving a redemption statement from an establishment, the redemption statement comprising a selected redemption rule and a selected patron, decrementing, according to the selected redemption rule, an account of incentive points of the patron, the account being stored in a patron database associated with the establishment.

3. The at least one tangible computer-readable medium of claim 2 further comprising:
prior to incrementing, according to the selected earning rule, the account of the patron sending a message to the patron to allow the patron to accept or reject the incentive points associated with the establishment;
responsive to the patron accepting the incentive points, incrementing, according to the selected earning rule, an account of incentive points of the patron, the account being stored in a patron database associated with the establishment; and
responsive to the patron rejecting the incentive points, not incrementing the account of the patron.

4. The at least one tangible computer-readable medium of claim 1 further comprising:
response to a request from a patron from a plurality of patrons registered with the incentive service to view one or more of the patron's incentive accounts, providing to the patron one or more user interfaces to view the patron's one or more incentive accounts wherein each incentive account is associated with an establishment.

5. The at least one tangible computer-readable medium of claim 1 further comprising:
responsive to a display and input device being provided at an establishment, the display and input device being communicatively coupled to the incentive service, providing to each of a plurality of patrons registered as users with the service one or more user interfaces using the display and input device to allow a patron to submit an identifier to record a visit to the establishment.

6. The at least one tangible computer-readable medium of claim 5 wherein the identifier is an email address and the step of providing to each of a plurality of patrons registered as users with the service one or more user interfaces using the display and input device to allow a patron to submit an identifier to record a visit to the establishment further comprises:
responsive to the patron entering an “@” symbol using the display and input device, displaying to the patron a set of one or more suggested domains from a set of possible domains extracted from a database of patrons to potentially assist the patron in completing entry of the email address.

7. The at least one tangible computer-readable medium of claim 6 further comprising:
responsive to the patron entering one or more characters after the “@” symbol, dynamically updating the set of one or more suggested domains, the updated set of one or more suggested domains being selected from the set of possible domains based, at least partially upon, having characters matching the one or more characters after the “@” symbol.

8. A promotion system operating on one or more computing devices for facilitating one or more promotions for one or more individuals to patronize one or more businesses, the system comprising:
a contacts datastore comprising one or more sets of data regarding contacts for each of a plurality of businesses, the one or more sets of data for a contact comprising contact identity data, contacting information for communicating with the contact via one or more communication channels, and data indicating which of the plurality of businesses the contact has patronized;
a promotions datastore that stores promotion data for each promotion from a set of promotions offered by at least one business from the plurality of businesses, the promotion data for a promotion comprising a promotion identifier, a business identifier to identify one or more businesses from the plurality of businesses that are associated with the promotion, and a set of one or more promotion rules configured by at least one business from the one or more businesses associated with the promotion;
a promotions rules engine, communicatively coupled to the contacts datastore and the promotions datastore, that, for a promotion, uses the set of rules associated with the promotion to identify which contacts from at least some of the contacts datastore should receive a promotion offer and to generate offers;
a promotions tracker datastore that stores data for each promotion from the set of promotions related to which contacts received a promotion offer and data related to which contacts participated in the promotion; and
a promotions distributor, communicatively coupled to the promotions rule engine and the promotions tracker datastore, that distributes the promotion offers generated by the promotions rule engine to the selected contacts and updates the promotions tracker datastore with data related to which contacts received a promotion offer and with data related to which contacts, if any, that participated in the promotion.

9. The promotion system of claim 8 wherein one or more terms of the promotion are customized for at least one contact according to at least one rule from the set of rules.

10. The promotions system of claim 9 wherein a time term of the promotion is different for at least some of the contacts that were sent the promotion offer.

11. The promotions system of claim 8 wherein at least one rule including a trigger condition for generating a promotion offer and a monitoring schedule, the rule engine monitors data in the promotion system according the monitoring schedule and generating a promotion offer responsive to the trigger condition being satisfied.

12. The promotions system of claim 8 further comprising:
a loyalty system that comprises a loyalty engine comprising, for each business from the plurality of businesses that has a loyalty program, at least one earning rule for earning incentive points and at least one redeeming rule for redeeming earned incentive points, and a transactions datastore that comprises customer data and each customer's associated transaction history; and
wherein the promotions rules engine is communicatively coupled to the transactions datastore and applies at least some of the set of rules associated with the promotion to generate promotion offers.

13. The promotions system of claim 12 wherein access by a business to the contacts in the contacts datastore and the transactions datastore is restricted to the contacts that have associated with the business in the datastores and wherein two or more businesses from the plurality of businesses form a collaborative promotion wherein the promotions rules engine applies at least some of a set of rules associated with the collaborative promotion the datastores accessible by the two or more business when to identify which contacts may be eligible for the promotion.

14. The promotions system of claim 13 wherein the collaborative promotion is directed, for at least one of the businesses, to target contacts that the at least one business would not otherwise have access to via the promotion system.

15. The promotions system of claim 8 wherein at least one of rules requires coordination between or among contacts.

16. A promotion system operating on one or more computing devices comprising one or more processing units communicatively coupled to one or more tangible computer-readable media storing data comprising:
at least one businesses database comprising one or more sets of data regarding a plurality of businesses of the promotion system, for each business the one or more sets of data comprise profile data about the business and a set of incentive rules comprising at least one earning rule for earning incentive points and at least one redemption rule for redeeming earned incentive points;
at least one users database comprising one or more sets of data regarding a plurality of users of the promotion system, for each user the one or more sets of data comprise user identity data, contact information for communicating with the user via one or more communication channels, and incentives accounts that provides an incentives account for each of one or more businesses from the plurality of businesses for which the user has established a connection; and
one or more sequences of instructions, wherein execution of the one or more sequences of instructions by one or more processing units causes steps to be performed comprising:
responsive to a request from a user to view incentive accounts of the user, providing one or more interfaces configured to display on a display device to the user, one or more incentive accounts of the user.

17. The promotion system of claim 16 wherein the one or more sequences of instructions further comprises:
responsive to a request from a business for a redemption action, providing to the business one or more interfaces to facilitate submission of a redemption statement, the one or more interfaces enabling the business to identify and select a redemption rule associated with the business and stored in the at least one businesses database and to identify in the at least one users database at least one user associated with the business that has sufficient incentive points to satisfy the redemption rule; and
responsive to receiving a redemption statement from the business, the redemption statement comprising the selected redemption rule and the selected user, decrementing, according to the selected redemption rule, the balance of incentive points of the user related to the business.

18. The promotion system of claim 16 wherein the one or more sequences of instructions further comprises:
responsive to a computing device being provided at a business, the computing device being communicatively coupled to the promotion system, providing to a user one or more interfaces at the computing device to allow the user to submit an identifier to record a visit to the business.

19. The promotion system of claim 18 wherein the identifier is an email address and the step of providing to a user one or more interfaces at the computing device to allow the user to submit an identifier to record a visit to the business further comprises:
responsive to the user entering an “@” symbol using the computing device, displaying to the user via the one or more interfaces a set of one or more suggested domains from a set of possible domains to potentially assist the user in completing entry of the email address; and
responsive to the user entering one or more characters after the “@” symbol, dynamically updating the set of one or more suggested domains, the updated set of one or more suggested domains being selected from the set of possible domains based, at least partially upon, having characters matching the one or more characters after the “@” symbol.

20. The promotion system of claim 18 further comprising:
a promotions datastore that stores promotion data for each promotion from a set of promotions offered by at least one business from the plurality of businesses, the promotion data for a promotion comprising a business identifier to identify one or more businesses from the plurality of businesses that are associated with the promotion, and a set of one or more promotion rules configured by at least one business from the one or more businesses associated with the promotion;
a promotions rules engine, communicatively coupled to the at least one users database and the promotions datastore, that, for a promotion, uses the set of rules associated with the promotion to identify which users from at least some of at least one users database should receive a promotion offer and to generate offers;
a promotions tracker datastore that stores data for each promotion from the set of promotions related to which users received a promotion offer and data related to which users participated in the promotion; and
a promotions distributor, communicatively coupled to the at least one users database and the promotions tracker datastore, that distributes the promotion offers generated by the promotions rule engine to the selected users and updates the promotions tracker datastore with data related to which users received a promotion offer and with data related to which users, if any, that participated in the promotion.
